(19) United States
(12) Patent Application Publication
(10) Pub. No.: US 2024/0271262 A1
(43) Pub. Date: Aug. 15, 2024

(54) STEEL MATERIAL

(71) Applicant: NIPPON STEEL CORPORATION, Tokhyo (JP)

(72) Inventor: Yusuke MIYAKOSHI, Chiyoda-ku, Tokyo (JP)

(21) Appl. No.: 18/681,571

(22) PCT Filed: Aug. 19, 2022
(86) PCT No.: PCT/JP2022/031349

§ 371 Date: Feb. 6, 2024

(30) Foreign Application Priority Data
Aug. 20, 2021 (JP) 2021-134877

(51) Int. Cl. C22C 38/60; C21D 1/32; C21D 6/00; C21D 8/06; C21D 9/52; C22C 38/00; C22C 38/02; C22C 38/04; C22C 38/06; C22C 38/20; C22C 38/22; C22C 38/24; C22C 38/26; C22C 38/28; C22C 38/32; C22C 38/44

(52) U.S. Cl. CPC C22C 38/60; C21D 1/32; C21D 6/002; C21D 6/004; C21D 6/005; C21D 6/008; C21D 8/065; C21D 9/525; C22C 38/002; C22C 38/005; C22C 38/02; C22C 38/04; C22C 38/06; C22C 38/20; C22C 38/22; C22C 38/24; C22C 38/26; C22C 38/28; C22C 38/32; C22C 38/44

(57) ABSTRACT

A steel material contains, in mass %, C: 0.30 to 0.50%, Si: 0.40% or less, Mn: 0.10 to 0.60%, P: 0.030% or less, S: 0.030% or less, Cr: 0.90 to 1.80%, Mo: 0.30 to 1.00%, Al: 0.005 to 0.100%, and N: 0.003 to 0.030%, with the balance comprising Fe and impurities. When a Cr concentration in an extraction residue obtained by electrolyzing and removing a region from a surface of the steel material to a depth position of 100±20 μm by performing a preliminary constant current electrolysis and thereafter further electrolyzing a region from a surface of the steel material to a depth position of 100±20 μm by performing a main constant current electrolysis is defined as “[Cr]” (mass %), and a Mo concentration in the extraction residue is defined as “[Mo]” (mass %), the steel material satisfies Formula (1).

$$10. \leq [ Cr ] + [ Mo ] \leq 30. \qquad ( 1 )$$

### TECHNICAL FIELD

The present disclosure relates to a steel material.

### BACKGROUND ART

A process for producing a part for machine structural use, which is represented by a cold-forged component such as a bolt, is as follows. For example, a steel material underwent spheroidizing annealing is subjected to a descaling treatment for the purpose of removing scale from the steel material. In the descaling treatment, a pickling treatment is performed on the steel material. The steel material after the descaling treatment is subjected to a lubricant coating treatment to apply a lubricant to the surface of the steel material. The steel material with the lubricant applied is subjected to wire drawing to produce a steel wire. The steel wire is forged to produce an intermediate product. The intermediate product is subjected to a heat treatment (such as a thermal refining treatment) to produce a part for machine structural use. In some cases, the intermediate product after forging is subjected to cutting.

As described above, in the case of a steel material to be used for a part for machine structural use, in some cases processing such as wire drawing (cold drawing) is performed before forging is performed to improve the dimensional accuracy. To suppress the occurrence of seizure with a wire drawing die, a lubricant coating treatment is performed on the steel material before wire drawing. In the lubricant coating treatment, a lubricant coating is formed on the surface of the steel material. For example, a chemical treatment coating is formed on the surface of the steel material. In addition, soap (metallic soap or the like) is adhered onto the chemical treatment coating.

In the production process described above, if scale remains on the surface of the steel material after the descaling treatment and before the lubricant coating treatment, the coating amount of the lubricant coating will be insufficient. That is, a lubricant adhesion property of the steel material will decrease. In this case, seizure will occur during wire drawing. Further, a pickling treatment is performed in the descaling treatment. In the pickling treatment, hydrogen is generated on the steel material surface. If hydrogen generated during the pickling treatment penetrates into the steel material, a hydrogen embrittlement resistance characteristic of the steel material will decrease. Therefore, a steel material for use for a part for machine structural use which it is planned to subject to a descaling treatment and thereafter a wire drawing process is required to have both an excellent hydrogen embrittlement resistance characteristic and an excellent lubricant adhesion property.

Steel materials that can be applied as a starting material for a part for machine structural use are proposed in International Application Publication No. WO2015/189978 (Patent Literature 1) and Japanese Patent Application Publication No. 2013-237903 (Patent Literature 2).

The steel material disclosed in Patent Literature 1 consists of, in mass %, C: 0.005 to 0.60%, Si: 0.01 to 0.50%, Mn: 0.20 to 1.80%, Al: 0.01 to 0.06%, P: 0.04% or less, S: 0.05% or less, N: 0.01% or less, Cr: 0 to 1.50%, Mo: 0 to 0.50%, Ni: 0 to 1.00%, V: 0 to 0.50%, B: 0 to 0.0050%, and Ti: 0 to 0.05%, with the balance being Fe and impurities. The steel micro-structure of this steel material includes pearlite. A value obtained by dividing the content of Mn in atomic percent contained in cementite in the pearlite by the content of Mn in atomic percent contained in ferrite in the pearlite is in the range of more than 0 to 5.0 or less. In this steel material, the chemical composition and steel micro-structure are controlled, and in addition, a Mn distribution ratio relating to cementite and ferrite in the pearlite is adjusted. It is described in Patent Literature 1 that, by this means, a spheroidizing annealing treatment time can be shortened.

A steel material for a bolt disclosed in Patent Literature 2 consists of, in mass %, C: 0.30 to 0.40%, Si: 0.01 to 0.40%, Mn: 0.10 to 1.0%, P: 0.030% or less, S: 0.030% or less, Al: 0.005 to 0.10%, Cr: 0.90 to 1.8%, Mo: 0.10 to 2.0%, N: 0.003 to 0.030%, and Nb: 0 to 0.10%, with the balance being Fe and impurities. In this steel material, a number ratio of carbides having an equivalent circular diameter of 1.0 μm or more among carbides having an equivalent circular diameter of 0.5 μm or more is 10% or less. In this steel material, the number ratio of coarse carbides is reduced. It is described in Patent Literature 2 that, by this means, carbides are sufficiently dissolved during quenching and hence variations in the tensile strength of the bolt product can be reduced.

### CITATION LIST

### Patent Literature

Patent Literature 1: International Application Publication No. WO2015/189978
Patent Literature 2: Japanese Patent Application Publication No. 2013-237903

### SUMMARY OF INVENTION

### Technical Problem

However, in Patent Literature 1 and Patent Literature 2, no consideration is given to a hydrogen embrittlement resistance characteristic of a steel material subjected to a pickling treatment as a descaling treatment before wire drawing, nor to a lubricant adhesion property of a steel material in a lubricant coating treatment before wire drawing.

An object of the present disclosure is to provide a steel material which is excellent in a hydrogen embrittlement resistance characteristic after a pickling treatment performed for the purpose of descaling, and is also excellent in a lubricant adhesion property.

### Solution to Problem

The steel material according to the present disclosure is as follows.

A steel material comprising, in mass %,

C: 0.30 to 0.50%,

Si: 0.40% or less,

Mn: 0.10 to 0.60%,

P: 0.030% or less,

S: 0.030% or less,

Cr: 0.90 to 1.80%,

Mo: 0.30 to 1.00%,

Al: 0.005 to 0.100%, and

N: 0.003 to 0.030%,

with the balance comprising Fe and impurities,

wherein:

when a Cr concentration in an extraction residue obtained by electrolyzing and removing a region from a surface of the steel material to a depth position of 100+20 μm by performing a preliminary constant current electrolysis and thereafter further electrolyzing a region from a surface of the steel material to a depth position of 100+20 μm by performing a main constant current electrolysis is defined as “[Cr]” (mass %), and a Mo concentration in the extraction residue is defined as “[Mo]” (mass %), the steel material satisfies Formula (1).

$$10. \leq [ Cr ] + [ Mo ] \leq 30. \qquad ( 1 )$$

### Advantageous Effects of Invention

The steel material of the present disclosure is excellent in a hydrogen embrittlement resistance characteristic after a pickling treatment performed for the purpose of descaling, and is also excellent in a lubricant adhesion property.

### BRIEF DESCRIPTION OF DRAWINGS

FIG. 1 is a view illustrating a region that is electrolyzed and removed by a preliminary constant current electrolysis.

FIG. 2 is a view illustrating a region that is electrolyzed by a constant current electrolysis after the preliminary constant current electrolysis.

### DESCRIPTION OF EMBODIMENTS

Initially the present inventors conducted studies regarding a steel material that can be applied as a starting material for a part for machine structural use, which is represented by a cold-forged component such as a bolt, from the viewpoint of the chemical composition. In addition, the present inventors investigated and considered the reason why hydrogen embrittlement occurs in a steel material after a pickling treatment when the steel material is subjected to a pickling treatment for the purpose of descaling. As a result, the present inventors obtained the following findings.

When a pickling treatment is performed on a steel material, the surface of the steel material dissolves. Further, hydrogen is generated on the steel material surface as the surface dissolves. If the hydrogen generated on the steel material surface penetrates into the steel material, the hydrogen will accumulate at grain boundaries. As a result, hydrogen embrittlement will occur in the steel material after the pickling treatment.

From the viewpoint of the chemical composition, the following approaches are conceivable as means for suppressing such kind of hydrogen embrittlement of a steel material after a pickling treatment.

(A) Increase the strength of the grains in the steel material. Specifically, suppress as much as possible the inclusion of Mn, P, and S which are elements that segregate at grain boundaries and lower the grain boundary strength.

(B) Suppress coarsening of grains in the steel material, and suppress the concentration of localized accumulation of hydrogen. Specifically, utilize the pinning effect of AlN. For this reason, contain appropriate amounts of Al and N.

Taking into account the technical idea described above, the present inventors considered that, as the chemical composition of a steel material that can be applied as a starting material for a part for machine structural use, if a chemical composition containing, in mass %, C: 0.30 to 0.50%, Si: 0.40% or less, Mn: 0.10 to 0.60%, P: 0.030% or less, S: 0.030% or less, Cr: 0.90 to 1.80%, Mo: 0.30 to 1.00%, Al: 0.005 to 0.100%, N: 0.003 to 0.030%, Cu: 0 to 0.40%, Ni: 0 to 0.40%, V: 0 to 0.50%, Ti: 0 to 0.100%, Nb: 0 to 0.100%, B: 0 to 0.0100%, W: 0 to 0.500%, Ca: 0 to 0.010%, Mg: 0 to 0.100%, rare earth metal: 0 to 0.100%, Bi: 0 to 0.300%, Te: 0 to 0.300%, and Zr: 0 to 0.300%, with the balance containing Fe and impurities is used, hydrogen embrittlement of the steel material after a pickling treatment can be suppressed.

In addition, the present inventors conducted studies regarding means for improving a hydrogen embrittlement resistance characteristic of the steel material after a pickling treatment from a viewpoint other than the chemical composition. As a result, the present inventors obtained the following findings.

In a pickling treatment, a steel portion in an outer layer region that is a region from the surface of the steel material to a depth of about 100 μm to 200 μm dissolves. Therefore, if excessive dissolution of the steel portion of the outer layer region can be suppressed, excessive generation of hydrogen can be suppressed. Here, during the pickling treatment, Cr and Mo form dense oxides on the steel material surface. In the present description, an oxide containing Cr and/or Mo is referred to as a “specific oxide”. During the pickling treatment, if specific oxides are formed on the steel material surface, direct contact of the acidic solution with the outer layer of the steel material can be suppressed. As a result, during the pickling treatment, excessive dissolution of the steel portion in the outer layer region is suppressed, and excessive generation of hydrogen is suppressed. The specific oxides formed on the steel material surface also suppress penetration by the hydrogen generated on the steel material surface. Therefore, by making a Cr concentration and Mo concentration fall within an appropriate range in an outer layer region of the steel material, generation of hydrogen during a pickling treatment and penetration of hydrogen into the steel material can be suppressed.

Cr and Mo are contained in carbides and carbo-nitrides, and are concentrated. Here, a Cr concentration in an extraction residue obtained by electrolyzing the outer layer region of a steel material having the aforementioned chemical composition by an electrolytic extraction method is defined as “[Cr]” (mass %). In addition, a Mo concentration in the aforementioned extraction residue is defined as “[Mo]” (mass %). The main kinds of extraction residues (inclusions and precipitates) of the outer layer region are carbides and carbo-nitrides. Hereunder, in the present description, carbides and carbo-nitrides are also referred to as “carbides and the like”. Thus, the Cr concentration [Cr] and Mo concentration [Mo] in an extraction residue of the outer layer region serve as an index of the Cr concentration and Mo concentration in the carbides and the like.

Therefore, the present inventors investigated and examined the relationship between the Cr concentration [Cr] and Mo concentration [Mo] in an extraction residue of the outer layer region and a hydrogen embrittlement resistance characteristic of a steel material after a pickling treatment. As a result, the present inventors discovered that, in a steel material in which the content of each element in the chemical composition is within the aforementioned range, if the total amount of the Cr concentration [Cr] and the Mo concentration [Mo] in an extraction residue of the outer layer region is 10.0% or more, a hydrogen embrittlement resistance characteristic of the steel material after a pickling treatment is enhanced.

On the other hand, in some cases, when the total amount of the Cr concentration [Cr] and Mo concentration [Mo] in the extraction residue of the outer layer region was excessively high, in a lubricant coating treatment performed at a stage which was after a pickling treatment performed for the purpose of descaling and was before wire drawing, the lubricant coating did not adhere sufficiently to the steel material. Therefore, the present inventors conducted further investigations regarding means for also increasing a lubricant adhesion property while enhancing the hydrogen embrittlement resistance characteristic of the steel material after a pickling treatment. Therefore, the present inventors conducted studies regarding the cause of the decrease in the lubricant adhesion property. As a result, the present inventors discovered that when the specific oxides are excessively formed on the surface of the steel material after a pickling treatment, the lubricant coating does not adhere sufficiently.

Based on the above findings, the present inventors conducted further studies regarding the total amount of the Cr concentration [Cr] and Mo concentration [Mo] in an extraction residue of an outer layer region. As a result, the present inventors discovered that in a steel material in which the content of each element in the chemical composition is within the aforementioned range, if the total amount of the Cr concentration [Cr] and Mo concentration [Mo] in an extraction residue of an outer layer region is 10.0% or more and 30.0% or less, it is possible to obtain both an excellent hydrogen embrittlement resistance characteristic and an excellent lubricant adhesion property in the steel material after a pickling treatment.

The steel material of the present embodiment has been completed based on the technical idea described above. The steel material of the present embodiment is as follows.

[1]

A steel material comprising, in mass %,

C: 0.30 to 0.50%,

Si: 0.40% or less,

Mn: 0.10 to 0.60%,

P: 0.030% or less,

S: 0.030% or less,

Cr: 0.90 to 1.80%,

Mo: 0.30 to 1.00%,

Al: 0.005 to 0.100%, and

N: 0.003 to 0.030%,

with the balance comprising Fe and impurities,

wherein:

when a Cr concentration in an extraction residue obtained by electrolyzing and removing a region from a surface of the steel material to a depth position of 100+20 μm by performing a preliminary constant current electrolysis and thereafter further electrolyzing a region from a surface of the steel material to a depth position of 100+20 μm by performing a main constant current electrolysis is defined as “[Cr]” (mass %), and a Mo concentration in the extraction residue is defined as “[Mo]” (mass %), the steel material satisfies Formula (1).

$$10. \leq [ Cr ] + [ Mo ] \leq 30. \qquad ( 1 )$$

[2]

The steel material according to [1], wherein:
a number ratio RN of carbides having an equivalent circular diameter of 0.8 μm or more with respect to a number of carbides having an equivalent circular diameter of 0.5 μm or more is 5 to 20%.
   [3]

The steel material according to [1] or [2], further containing, in lieu of a part of Fe, one or more kinds of element selected from a group consisting of:
Cu: 0.40% or less,
Ni: 0.40% or less,
V: 0.50% or less,
Ti: 0.100% or less,
Nb: 0.100% or less,
B: 0.0100% or less,
W: 0.500% or less,
Ca: 0.010% or less,
Mg: 0.100% or less,
rare earth metal: 0.100% or less,
Bi: 0.300% or less,
Te: 0.300% or less, and
Zr: 0.300% or less.

Hereunder, the steel material according to the present embodiment is described in detail. The symbol “%” in relation to an element means mass percent unless otherwise stated.

### [Features of Steel Material of Present Embodiment]

The steel material of the present embodiment satisfies the following Feature 1 and Feature 2.

### (Feature 1)

The chemical composition containing, in mass %, C: 0.30 to 0.50%, Si: 0.40% or less, Mn: 0.10 to 0.60%, P: 0.030% or less, S: 0.030% or less, Cr: 0.90 to 1.80%, Mo: 0.30 to 1.00%, Al: 0.005 to 0.100%, N: 0.003 to 0.030%, Cu: 0 to 0.40%, Ni: 0 to 0.40%, V: 0 to 0.50%, Ti: 0 to 0.100%, Nb: 0 to 0.100%, B: 0 to 0.0100%, W: 0 to 0.500%, Ca: 0 to 0.010%, Mg: 0 to 0.100%, rare earth metal: 0 to 0.100%, Bi: 0 to 0.300%, Te: 0 to 0.300%, and Zr: 0 to 0.300%, with the balance containing Fe and impurities.

### (Feature 2)

When a Cr concentration in an extraction residue obtained by electrolyzing and removing a region from the surface of the steel material to a depth position of 100+20 μm by performing a preliminary constant current electrolysis and thereafter further electrolyzing a region from the surface of the steel material to a depth position of 100+20 μm by performing a main constant current electrolysis is defined as “[Cr]” (mass %), and a Mo concentration in the extraction residue is defined as “[Mo]” (mass %), the steel material satisfies Formula (1).

$$10. \leq [ Cr ] + [ Mo ] \leq 30. \qquad ( 1 )$$

Hereunder, Feature 1 and Feature 2 are described.

### [(Feature 1) Regarding Chemical Composition]

The chemical composition of the steel material according to the present embodiment contains the following elements.

C: 0.30 to 0.50%

Carbon (C) increases the hardenability of the steel material and increases the strength of the steel material. If the content of C is less than 0.30%, the aforementioned advantageous effect cannot be sufficiently obtained even if the contents of other elements are within the range of the present embodiment.

On the other hand, if the content of C is more than 0.50%, the toughness of the steel material will decrease even if the contents of other elements are within the range of the present embodiment. In this case, in a process for producing a cold-forged component using the steel material as a starting material, the cold forging cracking resistance of the steel material will decrease.

Therefore, the content of C is to be 0.30 to 0.50%.

A preferable lower limit of the content of C is 0.31%, more preferably is 0.32%, and further preferably is 0.33%.

A preferable upper limit of the content of C is 0.48%, more preferably is 0.46%, and further preferably is 0.44%.

Si: 0.40% or less

Silicon (Si) is an impurity. Si reduces the toughness of the steel material. If the content of Si is more than 0.40%, even if the contents of other elements are within the range of the present embodiment, the toughness of the steel material will markedly decrease, and the cold forging cracking resistance of the steel material will decrease.

Therefore, the content of Si is to be 0.40% or less.

The content of Si is preferably as low as possible. However, excessively lowering the content of Si will decrease productivity and raise the production cost. Therefore, when taking into consideration normal industrial production, a preferable lower limit of the content of Si is more than 0%, more preferably is 0.01%, further preferably is 0.02%, and further preferably is 0.03%.

A preferable upper limit of the content of Si is 0.38%, more preferably is 0.36%, and further preferably is 0.34%.

Mn: 0.10 to 0.60%

Manganese (Mn) deoxidizes the steel. Mn also increases the hardenability of the steel material and increases the strength of the steel material. If the content of Mn is less than 0.10%, the aforementioned advantageous effects cannot be sufficiently obtained even if the contents of other elements are within the range of the present embodiment.

On the other hand, if the content of Mn is more than 0.60%, even if the contents of other elements are within the range of the present embodiment, Mn will segregate excessively at grain boundaries, which will cause the grain boundary strength to decrease. As a result, a hydrogen embrittlement resistance characteristic of the steel material will deteriorate.

Therefore, the content of Mn is to be 0.10 to 0.60%.

A preferable lower limit of the content of Mn is 0.12%, more preferably is 0.14%, and further preferably is 0.16%.

A preferable upper limit of the content of Mn is 0.58%, more preferably is 0.56%, and further preferably is 0.54%.

P: 0.030% or less

Phosphorus (P) is an impurity. P segregates at grain boundaries of the steel material and decreases the grain boundary strength. If the content of P is more than 0.030%, even if the contents of other elements are within the range of the present embodiment, the hydrogen embrittlement resistance characteristic of the steel material after a pickling treatment will deteriorate due to a decrease in the grain boundary strength.

Therefore, the content of P is to be 0.030% or less.

The content of P is preferably as low as possible. However, excessively lowering the content of P will decrease productivity and raise the production cost. Therefore, when taking into consideration normal industrial production, a preferable lower limit of the content of P is more than 0%, more preferably is 0.001%, further preferably is 0.002%, and further preferably is 0.003%.

A preferable upper limit of the content of P is 0.028%, more preferably is 0.026%, and further preferably is 0.024%.

S: 0.030% or less

Sulfur (S) is an impurity. S segregates at grain boundaries of the steel material and decreases the grain boundary strength. If the content of S is more than 0.030%, even if the contents of other elements are within the range of the present embodiment, the hydrogen embrittlement resistance characteristic of the steel material after a pickling treatment will deteriorate.

Therefore, the content of S is to be 0.030% or less.

The content of S is preferably as low as possible. However, excessively lowering the content of S will decrease productivity and raise the production cost. Therefore, when taking into consideration normal industrial production, a preferable lower limit of the content of S is more than 0%, more preferably is 0.001%, further preferably is 0.002%, and further preferably is 0.003%.

A preferable upper limit of the content of S is 0.028%, more preferably is 0.026%, and further preferably is 0.024%.

Cr: 0.90 to 1.80%

Chromium (Cr) dissolves in carbides, and forms specific oxides containing Cr and Mo on the steel material surface during a pickling treatment. Generation of hydrogen caused by excessive pickling is suppressed by formation of the specific oxides. As a result, the hydrogen embrittlement resistance characteristic of the steel material after a pickling treatment is enhanced. Cr also increases the hardenability of the steel material and increases the strength of the steel material. If the content of Cr is less than 0.90%, the aforementioned advantageous effects cannot be sufficiently obtained even if the contents of other elements are within the range of the present embodiment.

On the other hand, if the content of Cr is more than 1.80%, even if the contents of other elements are within the range of the present embodiment, the toughness of the steel material will decrease and the cold forging cracking resistance of the steel material will decrease.

Therefore, the content of Cr is to be 0.90 to 1.80%.

A preferable lower limit of the content of Cr is 0.91%, more preferably is 0.92%, and further preferably is 0.93%.

A preferable upper limit of the content of Cr is 1.75%, more preferably is 1.70%, and further preferably is 1.65%.

Mo: 0.30 to 1.00%

Molybdenum (Mo) dissolves in carbides, and forms specific oxides containing Cr and Mo on the steel material surface during a pickling treatment. Generation of hydrogen caused by excessive pickling is suppressed by formation of the specific oxides. As a result, the hydrogen embrittlement resistance characteristic of the steel material after a pickling treatment is enhanced. Mo also increases the hardenability of the steel material and increases the strength of the steel material. If the content of Mo is less than 0.30%, the aforementioned advantageous effects cannot be sufficiently obtained even if the contents of other elements are within the range of the present embodiment.

On the other hand, if the content of Mo is more than 1.00%, even if the contents of other elements are within the range of the present embodiment, the toughness of the steel material will decrease, and the cold forging cracking resistance of the steel material will decrease.

Therefore, the content of Mo is to be 0.30 to 1.00%.

A preferable lower limit of the content of Mo is 0.31%, more preferably is 0.32%, and further preferably is 0.33%.

A preferable upper limit of the content of Mo is 0.95%, more preferably is 0.90%, and further preferably is 0.85%.

Al: 0.005 to 0.100%

Aluminum (Al) deoxidizes the steel. Al also combines with N to form Al nitrides. The Al nitrides suppress the coarsening of grains, by the pinning effect. As a result, the hydrogen embrittlement resistance characteristic of the steel material after a pickling treatment is enhanced. If the content of Al is less than 0.005%, the aforementioned advantageous effect cannot be sufficiently obtained even if the contents of other elements are within the range of the present embodiment.

On the other hand, if the content of Al is more than 0.100%, even if the contents of other elements are within the range of the present embodiment, coarse Al nitrides will be formed. The coarse Al nitrides will serve as starting points for fractures. Consequently, the cold forging cracking resistance of the steel material will decrease.

Therefore, the content of Al is to be 0.005 to 0.100%.

A preferable lower limit of the content of Al is 0.006%, more preferably is 0.007%, and further preferably is 0.008%.

A preferable upper limit of the content of Al is 0.090%, more preferably is 0.080%, and further preferably is 0.070%.

In the chemical composition of the steel material of the present embodiment, the content of Al means the total Al content.

N: 0.003 to 0.030%

Nitrogen (N) combines with Al to form nitrides. The Al nitrides suppress the coarsening of grains, by the pinning effect. As a result, the hydrogen embrittlement resistance characteristic of the steel material after a pickling treatment is enhanced. If the content of N is less than 0.003%, the aforementioned advantageous effect cannot be sufficiently obtained even if the contents of other elements are within the range of the present embodiment.

On the other hand, if the content of N is more than 0.030%, even if the contents of other elements are within the range of the present embodiment, coarse nitrides will be formed. The coarse nitrides will serve as starting points for fractures. Consequently, the cold forging cracking resistance of the steel material will decrease.

Therefore, the content of N is to be 0.003 to 0.030%.

A preferable lower limit of the content of N is 0.004%, more preferably is 0.005%, and further preferably is 0.006%.

A preferable upper limit of the content of N is 0.029%, more preferably is 0.028%, and further preferably is 0.027%.

The balance in the chemical composition of the steel material of the present embodiment is Fe and impurities. Here, the term “impurities” refers to elements which, during industrial production of the steel material, are mixed in from ore or scrap that is used as a raw material, or from the production environment or the like, and which are allowed within a range that does not adversely affect the steel material of the present embodiment.

All elements other than the aforementioned impurities (P and S) may be mentioned as examples of impurities. The balance may include only one kind of impurity or may include two or more kinds of impurity. Examples of impurities other than the aforementioned impurities include Sb, Co, Sn and Zn. It is possible for a case to arise in which these elements are contained, for example, as impurities having the following contents. Sb: 0.01% or less, Co: 0.01% or less, Sn: 0.01% or less, and Zn: 0.01% or less.

### [Regarding Optional Elements]

The chemical composition of the steel material of the present embodiment may further contain one or more kinds of element selected from the following first group to fifth group in lieu of a part of Fe.

### [First Group]

One or more kinds of element selected from the group consisting of:
Cu: 0.40% or less, and
Ni: 0.40% or less.

### [Second Group]

One or more kinds of element selected from the group consisting of:
V: 0.50% or less,
Ti: 0.100% or less, and
Nb: 0.100% or less.

### [Third Group]

B: 0.0100% or less

### [Fourth Group]

W: 0.500% or less

### [Fifth Group]

One or more kinds of element selected from the group consisting of:
Ca: 0.010% or less,
Mg: 0.100% or less,
rare earth metal: 0.100% or less,
Bi: 0.300% or less,
Te: 0.300% or less, and
Zr: 0.300% or less.

Hereunder, these optional elements are described.

### [First Group (Cu and Ni)]

The chemical composition of the steel material of the present embodiment may further contain one or more kinds of element selected from a group consisting of Cu: 0.40% or less and Ni: 0.40% or less, in lieu of a part of Fe. Each of these elements is an optional element, and does not have to be contained. When contained, Cu and Ni form dense oxides during a pickling treatment. Therefore, generation of hydrogen that is caused by excessive pickling is suppressed. As a result, a hydrogen embrittlement resistance characteristic during a pickling treatment of the steel material of the present embodiment is enhanced. Hereunder, Cu and Ni are described.

Cu: 0.40% or less

Copper (Cu) is an optional element, and does not have to be contained. That is, the content of Cu may be 0%.

When Cu is contained, Cu forms dense oxides during a pickling treatment. By this means, generation of hydrogen that is caused by excessive pickling is suppressed. Therefore, the hydrogen embrittlement resistance characteristic of the steel material after a pickling treatment is enhanced. If even a small amount of Cu is contained, the aforementioned advantageous effect will be obtained to a certain extent.

However, if the content of Cu is more than 0.40%, even if the contents of other elements are within the range of the present embodiment, descaling of the steel material after a pickling treatment will be insufficient. As a result, the lubricant adhesion property of the steel material will deteriorate.

Therefore, the content of Cu is to be 0 to 0.40%, and when contained, the content of Cu is to be 0.40% or less.

A preferable lower limit of the content of Cu is more than 0%, more preferably is 0.01%, further preferably is 0.02%, and further preferably is 0.03%.

A preferable upper limit of the content of Cu is 0.35%, more preferably is 0.30%, and further preferably is 0.25%.

Ni: 0.40% or less

Nickel (Ni) is an optional element, and does not have to be contained. That is, the content of Ni may be 0%.

When Ni is contained, Ni forms dense oxides during a pickling treatment. By this means, generation of hydrogen that is caused by excessive pickling is suppressed. As a result, the hydrogen embrittlement resistance characteristic of the steel material after a pickling treatment is enhanced. If even a small amount of Ni is contained, the aforementioned advantageous effect will be obtained to a certain extent.

However, if the content of Ni is more than 0.40%, even if the contents of other elements are within the range of the present embodiment, descaling of the steel material after a pickling treatment will be insufficient. As a result, the lubricant adhesion property of the steel material will deteriorate.

Therefore, the content of Ni is to be 0 to 0.40%, and when contained, the content of Ni is to be 0.40% or less.

A preferable lower limit of the content of Ni is more than 0%, more preferably is 0.01%, further preferably is 0.02%, and further preferably is 0.03%.

A preferable upper limit of the content of Ni is 0.35%, more preferably is 0.30%, and further preferably is 0.25%.

[Second group (V, Ti and Nb)]

The chemical composition of the steel material of the present embodiment may further contain one or more kinds of element selected from a group consisting of V: 0.50% or less, Ti: 0.100% or less, and Nb: 0.100% or less, in lieu of a part of Fe. Each of these elements is an optional element, and does not have to be contained. When contained, V, Ti, and Nb combine with C and N to form carbo-nitrides.

These carbo-nitrides suppress the coarsening of grains, by the pinning effect. As a result, the hydrogen embrittlement resistance characteristic of the steel material after a pickling treatment is enhanced. Hereunder, V, Ti and Nb are described.

V: 0.50% or less

Vanadium (V) is an optional element, and does not have to be contained. That is, the content of V may be 0%.

When V is contained, V combines with C and N to form carbo-nitrides, which suppresses the coarsening of grains. As a result, the hydrogen embrittlement resistance characteristic of the steel material after a pickling treatment is enhanced. If even a small amount of V is contained, the aforementioned advantageous effect will be obtained to a certain extent.

However, if the content of V is more than 0.50%, even if the contents of other elements are within the range of the present embodiment, coarse carbo-nitrides will form. The coarse carbo-nitrides will serve as starting points for fractures. Consequently, the cold forging cracking resistance of the steel material will decrease.

Therefore, the content of V is to be 0 to 0.50%, and when contained, the content of V is to be 0.50% or less.

A preferable lower limit of the content of V is more than 0%, more preferably is 0.01%, further preferably is 0.02%, and further preferably is 0.03%.

A preferable upper limit of the content of V is 0.45%, more preferably is 0.40%, and further preferably is 0.35%.

Ti: 0.100% or less

Titanium (Ti) is an optional element, and does not have to be contained. That is, the content of Ti may be 0%.

When Ti is contained, that is, when the content of Ti is more than 0%, Ti combines with C and N to form carbo-nitrides, which suppresses the coarsening of grains. As a result, the hydrogen embrittlement resistance characteristic of the steel material after a pickling treatment is enhanced. If even a small amount of Ti is contained, the aforementioned advantageous effect will be obtained to a certain extent.

However, if the content of Ti is more than 0.100%, even if the contents of other elements are within the range of the present embodiment, coarse carbo-nitrides will form. The coarse carbo-nitrides will serve as starting points for fractures. Consequently, the cold forging cracking resistance of the steel material will decrease.

Therefore, the content of Ti is to be 0 to 0.100%, and when contained, the content of Ti is to be 0.100% or less.

A preferable lower limit of the content of Ti is more than 0%, more preferably is 0.001%, further preferably is 0.002%, and further preferably is 0.003%.

A preferable upper limit of the content of Ti is 0.080%, more preferably is 0.060%, and further preferably is 0.040%.

Nb: 0.100% or less

Niobium (Nb) is an optional element, and does not have to be contained. That is, the content of Nb may be 0%.

When Nb is contained, that is, when the content of Nb is more than 0%, Nb combines with C and N to form carbo-nitrides, which suppresses the coarsening of grains. As a result, the hydrogen embrittlement resistance characteristic of the steel material after a pickling treatment is enhanced. If even a small amount of Nb is contained, the aforementioned advantageous effect will be obtained to a certain extent.

However, if the content of Nb is more than 0.100%, even if the contents of other elements are within the range of the present embodiment, coarse carbo-nitrides will form. The coarse carbo-nitrides will serve as starting points for fractures. Consequently, the cold forging cracking resistance of the steel material will decrease.

Therefore, the content of Nb is to be 0 to 0.100%, and when contained, the content of Nb is to be 0.100% or less.

A preferable lower limit of the content of Nb is more than 0%, more preferably is 0.001%, further preferably is 0.002%, and further preferably is 0.003%.

A preferable upper limit of the content of Nb is 0.080%, more preferably is 0.060%, and further preferably is 0.040%.

### [Third Group (B)]

The chemical composition of the steel material of the present embodiment may further contain B in an amount of 0.0100% or less in lieu of a part of Fe. B is an optional element, and does not have to be contained.

B: 0.0100% or less

Boron (B) is an optional element, and does not have to be contained. That is, the content of B may be 0%.

When B is contained, B enhances the hardenability of the steel material. If even a small amount of B is contained, the aforementioned advantageous effect will be obtained to a certain extent.

However, if the content of B is more than 0.0100%, the hardenability of the steel material will be saturated, and the production cost will increase. In addition, even if the contents of other elements are within the range of the present embodiment, coarse nitrides will be formed. The coarse nitrides will serve as starting points for fractures. Consequently, the cold forging cracking resistance of the steel material will decrease.

Therefore, the content of B is to be 0 to 0.0100%, and when contained, the content of B is to be 0.0100% or less.

A preferable lower limit of the content of B is more than 0%, more preferably is 0.0001%, further preferably is 0.0002%, and further preferably is 0.0003%. A preferable upper limit of the content of B is 0.0080%, more preferably is 0.0060%, and further preferably is 0.0040%.

### [Fourth Group (W)]

The chemical composition of the steel material of the present embodiment may further contain W in an amount of 0.500% or less in lieu of a part of Fe. W is an optional element, and does not have to be contained.

W: 0.500% or less

Tungsten (W) is an optional element, and does not have to be contained. That is, the content of W may be 0%.

When W is contained, W enhances the hardenability of the steel material and increases the strength of the steel material. If even a small amount of W is contained, the aforementioned advantageous effect will be obtained to a certain extent.

However, if the content of W is more than 0.500%, the toughness of the steel material will decrease, and the cold forging cracking resistance of the steel material will decrease.

Therefore, the content of W is to be 0 to 0.500%, and when contained, the content of W is to be 0.500% or less.

A preferable lower limit of the content of W is more than 0%, more preferably is 0.005%, and further preferably is 0.010%.

A preferable upper limit of the content of W is 0.480%, more preferably is 0.460%, and further preferably is 0.440%.

[Fifth group (Ca, Mg, rare earth metal, Bi, Te and Zr)]

The chemical composition of the steel material of the present embodiment may further contain one or more kinds of element selected from a group consisting of Ca: 0.010% or less, Mg: 0.100% or less, rare earth metal (REM): 0.100% or less, Bi: 0.300% or less, Te: 0.300% or less, and Zr: 0.300% or less, in lieu of a part of Fe. Each of these elements is an optional element and does not have to be contained. When contained, Ca, Mg, REM, Bi, Te and Zr each increase the machinability of the steel material. Hereunder, Ca, Mg, REM, Bi, Te and Zr are described.

Ca: 0.010% or less

Calcium (Ca) is an optional element, and does not have to be contained. That is, the content of Ca may be 0%.

When Ca is contained, Ca enhances the machinability of the steel material. If even a small amount of Ca is contained, the aforementioned advantageous effect will be obtained to a certain extent.

However, if the content of Ca is more than 0.010%, the hot ductility of the steel material will decrease even if the contents of other elements are within the range of the present embodiment.

Therefore, the content of Ca is to be 0 to 0.010%, and when contained, the content of Ca is to be 0.010% or less.

A preferable lower limit of the content of Ca is more than 0%, more preferably is 0.001%, further preferably is 0.002%, and further preferably is 0.003%.

A preferable upper limit of the content of Ca is 0.008%, more preferably is 0.006%, and further preferably is 0.004%.

Mg: 0.100% or less

Magnesium (Mg) is an optional element, and does not have to be contained. That is, the content of Mg may be 0%.

When Mg is contained, Mg enhances the machinability of the steel material. If even a small amount of Mg is contained, the aforementioned advantageous effect will be obtained to a certain extent.

However, if the content of Mg is more than 0.100%, the hot ductility of the steel material will decrease even if the contents of other elements are within the range of the present embodiment.

Therefore, the content of Mg is to be 0 to 0.100%, and when contained, the content of Mg is to be 0.100% or less.

A preferable lower limit of the content of Mg is more than 0%, more preferably is 0.001%, further preferably is 0.002%, and further preferably is 0.003%.

A preferable upper limit of the content of Mg is 0.090%, more preferably is 0.085%, and further preferably is 0.080%.

Rare earth metal: 0.100% or less

Rare earth metal (REM) is an optional element, and does not have to be contained. That is, the content of REM may be 0%.

When REM is contained, REM enhances the machinability of the steel material. If even a small amount of REM is contained, the aforementioned advantageous effect will be obtained to a certain extent.

However, if the content of REM is more than 0.100%, the hot ductility of the steel material will decrease even if the contents of other elements are within the range of the present embodiment.

Therefore, the content of REM is to be 0 to 0.100%, and when contained, the content of REM is to be 0.100% or less.

A preferable lower limit of the content of REM is more than 0%, more preferably is 0.001%, further preferably is 0.002%, and further preferably is 0.003%.

A preferable upper limit of the content of REM is 0.090%, more preferably is 0.085%, and further preferably is 0.080%.

Note that, in the present description the term “REM” means one or more kinds of element selected from the group consisting of scandium (Sc) which is the element with atomic number 21, yttrium (Y) which is the element with atomic number 39, and the elements from lanthanum (La) with atomic number 57 to lutetium (Lu) with atomic number 71 that are lanthanoids. Further, in the present description the term “content of REM” refers to the total content of these elements.

Bi: 0.300% or less

Bismuth (Bi) is an optional element, and does not have to be contained. That is, the content of Bi may be 0%.

When Bi is contained, Bi enhances the machinability of the steel material. If even a small amount of Bi is contained, the aforementioned advantageous effect will be obtained to a certain extent.

However, if the content of Bi is more than 0.300%, the hot ductility of the steel material will decrease even if the contents of other elements are within the range of the present embodiment.

Therefore, the content of Bi is to be 0 to 0.300%, and when contained, the content of Bi is to be 0.300% or less.

A preferable lower limit of the content of Bi is more than 0%, more preferably is 0.001%, further preferably is 0.002%, and further preferably is 0.003%.

A preferable upper limit of the content of Bi is 0.280%, more preferably is 0.260%, and further preferably is 0.240%.

Te: 0.300% or less

Tellurium (Te) is an optional element, and does not have to be contained. That is, the content of Te may be 0%.

When Te is contained, Te enhances the machinability of the steel material. If even a small amount of Te is contained, the aforementioned advantageous effect will be obtained to a certain extent.

However, if the content of Te is more than 0.300%, the hot ductility of the steel material will decrease even if the contents of other elements are within the range of the present embodiment.

Therefore, the content of Te is to be 0 to 0.300%, and when contained, the content of Te is to be 0.300% or less.

A preferable lower limit of the content of Te is more than 0%, more preferably is 0.001%, further preferably is 0.002%, and further preferably is 0.003%.

A preferable upper limit of the content of Te is 0.280%, more preferably is 0.260%, and further preferably is 0.240%.

Zr: 0.300% or less

Zirconium (Zr) is an optional element, and does not have to be contained. That is, the content of Zr may be 0%.

When Zr is contained, Zr enhances the machinability of the steel material. If even a small amount of Zr is contained, the aforementioned advantageous effect will be obtained to a certain extent.

However, if the content of Zr is more than 0.300%, the hot ductility of the steel material will decrease even if the contents of other elements are within the range of the present embodiment.

Therefore, the content of Zr is to be 0 to 0.300%, and when contained, the content of Zr is to be 0.300% or less.

A preferable lower limit of the content of Zr is more than 0%, more preferably is 0.001%, further preferably is 0.002%, and further preferably is 0.003%.

A preferable upper limit of the content of Zr is 0.280%, more preferably is 0.260%, and further preferably is 0.240%.

### [Method for Measuring Chemical Composition of Steel Material]

The chemical composition of the steel material of the present embodiment can be measured by a well-known component analysis method (JIS G 0321: 2017).

Specifically, machined chip are collected from an R/2 portion of the steel material using a drill. Here, the term “R/2 portion” means the central portion of a radius R of the steel material in a cross section perpendicular to the axial direction (rolling direction) of the steel material. The collected machined chips are dissolved in acid to obtain a liquid solution. The liquid solution is subjected to ICP-AES (Inductively Coupled Plasma Atomic Emission Spectrometry) to perform elementary analysis of the chemical composition. The content of C and the content of S are determined by a well-known high-frequency combustion method (combustion-infrared absorption method). The content of N is determined using a well-known inert gas fusion-thermal conductivity method.

### [(Feature 2) Regarding Cr Concentration [Cr] and Mo Concentration [Mo] in Extraction Residue]

According to the steel material of the present embodiment, when a Cr concentration in an extraction residue obtained by electrolyzing and removing a region from the surface of the steel material to a depth position of 100+20 μm by performing a preliminary constant current electrolysis and thereafter further electrolyzing a region from the surface of the steel material to a depth position of 100±20 μm by performing a main constant current electrolysis is defined as “[Cr]” (mass %), and a Mo concentration in the extraction residue is defined as “[Mo]” (mass %), the steel material also satisfies Formula (1).

$$10. \leq [ Cr ] + [ Mo ] \leq 30. \qquad ( 1 )$$

Here, the phrase “region from the surface to a depth position of 100+20 μm” means the region between the surface and a depth of D μm from the surface. The phrase “from the surface to a depth position of 100+20 μm” means that a depth D from the surface is within a range of 80 to 120 μm.

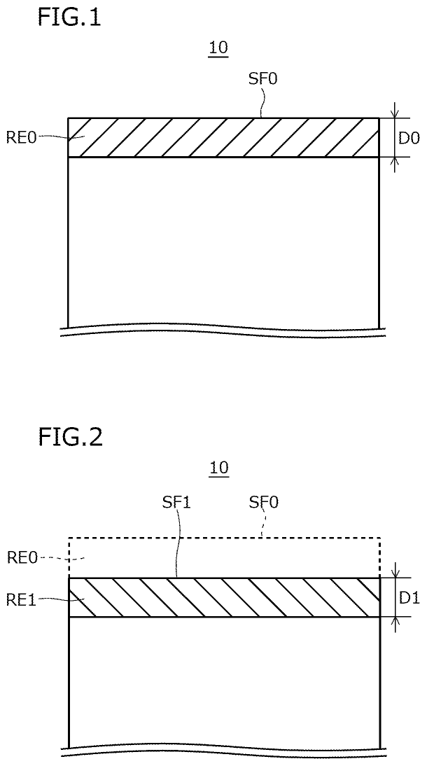

FIG. 1 is a view illustrating a region that is electrolyzed and removed by a preliminary constant current electrolysis. FIG. 2 is a view illustrating a region that is electrolyzed by a constant current electrolysis after the preliminary constant current electrolysis. Referring to FIG. 1 and FIG. 2, first, an outermost layer region RE0 from a surface SF0 to a depth D0 (D0=80 to 120 μm) of a steel material 10 is electrolyzed and removed by a preliminary constant current electrolysis. Thereafter, referring to FIG. 2, an actual outer layer region RE1 that is the region from an outer layer SF1 to a depth D1 (D1=80 to 120 μm) of the steel material 10 after the outermost layer region RE0 was removed is electrolyzed by a constant current electrolysis to obtain an extraction residue. That is, the aforementioned Cr concentration [Cr] and Mo concentration [Mo] in an extraction residue is a Cr concentration [Cr] and a Mo concentration [Mo] in an extraction residue obtained in the actual outer layer region RE1.

In the steel material 10, the outermost layer region RE0 which is removed by the preliminary constant current electrolysis includes scale that is formed on the steel material surface, and impurities that adhere to the steel material surface. Therefore, the outermost layer region RE0 is not used for measurement of the Cr concentration [Cr] and the Mo concentration [Mo] in an extraction residue, and instead the Cr concentration [Cr] and Mo concentration [Mo] in an extraction residue obtained in the actual outer layer region RE1 in which the influence of scale and impurities is extremely small are measured. Note that, it is considered that as long as there is no influence from scale and impurities, the values obtained for the Cr concentration [Cr] and Mo concentration [Mo] in an extraction residue obtained in the outermost layer region RE0 will be approximately the same as the values obtained for the Cr concentration [Cr] and Mo concentration [Mo] in an extraction residue obtained in the actual outer layer region RE1. Hereunder, a method for measuring the Cr concentration [Cr] and the Mo concentration [Mo] in the extraction residue will be described.

### [Method for Measuring Cr Concentration [Cr] and Mo Concentration [Mo] in Extraction Residue]

The Cr concentration [Cr] and Mo concentration [Mo] in the extraction residue obtained in the actual outer layer region RE1 are determined by the following method.

The steel material is cut perpendicularly to the axial direction (rolling direction) of the steel material to obtain a sample steel material. A cross section perpendicular to the axial direction of the sample steel material corresponds to the cross section of the steel material. The cut surface of the sample steel material is coated with an insulating resin.

The sample whose cut surface has been coated is subjected to a constant current electrolysis using a 10% AA-based solution (a solution containing, in volume fraction, 10% acetylacetone, 1% tetramethylammonium chloride, and 89% methanol solution).

First, a preliminary constant current electrolysis is performed to remove an outermost layer region RE0 of the sample steel material. In the preliminary constant current electrolysis, a current of 1000 mA is applied at normal temperature (15 to 30° C.) to electrolyze the region RE0 from a surface SF0 of the sample steel material to a depth position of D0=100+20 μm to remove the region RE0 from the sample steel material. The +20 μm of the depth position is an allowable error range. After the preliminary constant current electrolysis, the sample steel material is immersed in an alcohol solution. Ultrasonic cleaning is then performed to remove deposits on the surface of the sample steel material. The mass of the sample steel material from which deposits have been removed, that is, the mass of the sample steel material before performing a main constant current electrolysis is measured.

Next, an actual outer layer region RE1 of the sample steel material is subjected to the main constant current electrolysis. Specifically, a new 10% AA-based solution is prepared. Then, using the new 10% AA-based solution, a region RE1 from a surface SF1 of the sample steel material to a depth position of D1=100+20 μm is electrolyzed at normal temperature while maintaining the current density at 30 mA/cm². The +20 μm of the depth position is an allowable error range. The depth of the electrolyzed region RE1 is determined based on the difference in mass (amount of decrease) (g) in the sample steel material between before and after the main constant current electrolysis when taking the specific gravity of the sample steel material as 7.8 g/cm³, and the surface area of the surface (excluding the cross section) of the sample steel material. After the main constant current electrolysis, the sample steel material is immersed in an alcohol solution, and thereafter subjected to ultrasonic cleaning to remove deposits on the surface of the sample steel material.

The 10% AA-based solution used in the main constant current electrolysis, and the alcohol solution used in the ultrasonic cleaning thereafter are suction filtered through a filter with a mesh size of 0.2 μm to extract residue. That is, an extraction residue in the actual outer layer region RE1 electrolyzed by the main constant current electrolysis is obtained.

The extraction residue is subjected to chemical elemental analysis using ICP-AES. Specifically, the extraction residue is dissolved in acid to obtain a solution. The solution is subjected to chemical elemental analysis using ICP-AES to obtain the Cr mass in the extraction residue and the Mo mass in the extraction residue. Specifically, the Cr mass is divided by the total mass of the extraction residue to obtain the Cr concentration [Cr] (mass %) in the extraction residue. Similarly, the Mo mass is divided by the total mass of the extraction residue to obtain the Mo concentration [Mo] (mass %) in the extraction residue.

Let F1 be defined as F1=[Cr]+[Mo]. The extraction residue of the actual outer layer region RE1 obtained by the method described above includes inclusions and precipitates. The precipitates include carbides, carbo-nitrides, and nitrides. However, the main types of precipitates in the extraction residue are carbides and carbo-nitrides. Therefore, although F1 indicates the total amount of the Cr concentration and the Mo concentration in the extraction residue, actually F1 can serve as an index of the Cr concentration and the Mo concentration in the carbides and carbo-nitrides. It can be considered that if the Cr concentration and Mo concentration in the carbides and carbo-nitrides are high, the Cr concentration and the Mo concentration dissolved in the steel material are also high. Thus, F1 is also an index of the Cr concentration and Mo concentration dissolved in the outer layer of the steel material.

If F1 is less than 10.0, the total amount of the Cr concentration and Mo concentration in the extraction residue of the steel material outer layer will be insufficient. In such a case, the dissolved Cr concentration and the dissolved Mo concentration in the outer layer of the steel material will be insufficient. Consequently, during a pickling treatment, the specific oxides containing Cr and Mo will not be sufficiently formed on the steel material surface. Therefore, even if the content of each element in the chemical composition of the steel material is within the aforementioned range, hydrogen will be excessively generated on the steel material surface by the pickling, and the generated hydrogen will be liable to penetrate into the steel material. As a result, the hydrogen embrittlement resistance characteristic of the steel material after the pickling treatment will deteriorate.

On the other hand, if F1 is more than 30.0, the total amount of the Cr concentration and the Mo concentration in the extraction residue of the outer layer of the steel material will be excessively large. In such a case, the dissolved Cr concentration and dissolved Mo concentration in the outer layer of the steel material will be too high. Consequently, during pickling of the steel material, an excessively large amount of specific oxides will form on the steel material surface. In such a case, in a lubricant coating treatment performed after the pickling treatment and before wire drawing, it will be difficult for a lubricant coating to adhere to the steel material surface. Specifically, the lubricant coating reacts with Fe on the steel material surface to enhance the adhesiveness to the steel material surface. However, when the specific oxides are excessively formed on the steel material surface, it is difficult for the lubricant coating to react with Fe on the steel material surface due to the specific oxides. Therefore, the lubricant adhesion property with respect to the steel material surface deteriorates.

If F1 is 10.0 to 30.0, the total amount of the Cr concentration and Mo concentration in the extraction residue of the outer layer of the steel material will be a suitable amount. In such a case, the dissolved Cr concentration and dissolved Mo concentration in the outer layer of the steel material will also be suitable amounts. Therefore, during a pickling treatment, a suitable amount of the specific oxides will be formed on the steel material surface. As a result, the hydrogen embrittlement resistance characteristic of the steel material after a pickling treatment will be enhanced. In addition, during a pickling treatment, specific oxides will not form excessively on the steel material surface. Therefore, in a lubricant coating treatment before wire drawing, it will be easy for the lubricant coating to react with Fe on the steel material surface. As a result, the adhesiveness of the lubricant coating to the steel material surface will increase, and the lubricant adhesion property of the steel material will be enhanced.

A preferable lower limit of F1 is 11.0, more preferably is 12.0, and further preferably is 13.0.

A preferable upper limit of F1 is 29.0, more preferably is 28.0, and further preferably is 27.0.

### [Preferable Form of Steel Material of Present Embodiment]

Preferably, in addition to satisfying Feature 1 and Feature 2, the steel material of the present embodiment also satisfies Feature 3.

### (Feature 3)

A number ratio of carbides having an equivalent circular diameter of 0.8 μm or more with respect to a number of carbides having an equivalent circular diameter of 0.5 μm or more is 5 to 20%.

Hereunder, Feature 3 is described.

### [(Feature 3) Regarding Preferable Coarse Carbides Number Ratio RN]

Among the carbides in the steel material, carbides having an equivalent circular diameter of 0.8 μm or more are defined as “coarse carbides”. The number ratio of coarse carbides with respect to the number of carbides having an equivalent circular diameter of 0.5 μm or more is defined as “coarse carbides number ratio RN (%)”. The coarse carbides number ratio RN can be defined by the following formula.

$$RN = number of coarse carbides / number of carbides having an equivalent circular diameter of 0.5 μm or more \times 100$$

Note that, in a steel material that satisfies Feature 1 and Feature 2, carbides having an equivalent circular diameter of 0.5 μm or more are substantially cementite (Fe₃C), and the other carbides (also including carbo-nitrides) are negligible.

If a steel material satisfies Feature 1 and Feature 2, without particularly limiting the coarse carbides number ratio RN, the hydrogen embrittlement resistance characteristic of the steel material after a pickling treatment will be enhanced and the lubricant adhesion property of the steel material will also be enhanced.

Preferably, the coarse carbides number ratio RN in a steel material that satisfies Feature 1 and Feature 2 is 5 to 20%. If the coarse carbides number ratio RN is 5% or more, the hydrogen embrittlement resistance characteristic of the steel material after a pickling treatment will be further enhanced. Further, if the coarse carbides number ratio RN is 20% or less, the lubricant adhesion property of the steel material will be further enhanced. Therefore, a preferable coarse carbides number ratio RN is 5 to 20%.

A more preferable lower limit of the coarse carbides number ratio RN is 6%, more preferably is 7%, and further preferably is 8%.

A more preferable upper limit of the coarse carbides number ratio RN is 19%, more preferably is 18%, and further preferably is 17%.

### [Method for Measuring Coarse Carbides Number Ratio RN]

The coarse carbides number ratio RN of a steel material can be measured by the following method.

The steel material is cut perpendicularly to the axial direction (rolling direction) of the steel material at six different positions in the longitudinal direction of the steel material, and six sample steel materials are collected. A cross section perpendicular to the axial direction of each sample steel material corresponds to a cross section of the steel material. Among the surfaces of each sample steel material, a cut surface which is perpendicular to the axial direction is adopted as an observation surface. The observation surface is etched with a picral etchant to reveal carbides.

A region extending from the steel material surface to a depth position of 100 μm to 200 μm (actual outer layer region RE1) of the observation surface is taken as an observation region. A scanning electron microscope is used to generate photographic images (secondary electron images) of an arbitrary six visual fields at a magnification of 5000× in the observation region. The area of each visual field is set to 19 μm×25 μm.

In the photographic image of each visual field, carbides are identified using contrast. The equivalent circular diameters of the identified carbides are calculated. Among the carbides, those carbides having an equivalent circular diameter of 0.5 μm or more are taken as the measurement objects. In each visual field, the number of carbides having an equivalent circular diameter of 0.5 μm or more, and the number of carbides having an equivalent circular diameter of 0.8 μm or more (coarse carbides) are determined. The ratio (%) of the total number of coarse carbides with respect to the total number of carbides having an equivalent circular diameter of 0.5 μm or more in all of the visual fields (6×6=36 visual fields: total area of 17400 μm²) is defined as the coarse carbides number ratio RN (%).

### [Regarding Microstructure]

The microstructure of the steel material according to the present embodiment is not particularly limited. The steel material of the present embodiment is used as a starting material for a part for machine structural use. In the process for producing a part for machine structural use, a heat treatment such as a thermal refining treatment is performed. That is, the structure of the steel material used as the starting material undergoes a phase transformation due to the heat treatment such as a thermal refining treatment. Therefore, as mentioned above, the microstructure itself of the steel material that is used as the starting material for a part for machine structural use is not particularly limited.

The microstructure of the steel material of the present embodiment is a structure that, for example, contains a BCC phase, which is a phase whose crystal structure is a body-centered cubic (BCC) structure, and carbides which are dispersed in the BCC phase. In the present description, a structure composed of a BCC phase and carbides which are dispersed in the BCC phase is referred to as a “BCC structure”. The carbides contained in the BCC structure are, for example, cementite. The cementite may be lamellar cementite or may be spherical cementite. The cementite may be present in the form of a spot array in the BCC phase.

### [Method for Identifying Microstructure]

The microstructure can be identified by the following method. A test specimen including an R/2 portion is taken from a cross section perpendicular to the axial direction (rolling direction) of the steel material. Among the surfaces of the test specimen, a surface corresponding to the cross section perpendicular to the axial direction of the steel material is adopted as an observation surface.

After mirror-polishing the observation surface, the observation surface is etched using 2% nitric acid-alcohol (nital etchant). The R/2 portion in the etched observation surface is observed using an optical microscope with a magnification of 400×. The area of the observation visual field is set to 500 μm×500 μm.

In the BCC structure in the observation visual field, the BCC phase and the carbides can be identified based on the contrast and the morphology.

### [Regarding Form and Preferred Use of Steel Material of Present Embodiment]

The steel material of the present embodiment may be a steel bar or may be a wire rod. The diameter of the steel material is not particularly limited. The diameter of the steel material is, for example, 5 to 50 mm.

The steel material of the present embodiment is excellent in a hydrogen embrittlement resistance characteristic after a pickling treatment in a case where the steel material is subjected to a descaling treatment by performing a pickling treatment and in a lubricant adhesion property. Therefore, the steel material of the present embodiment is suitable as a steel material for cold working applications that are represented by wire drawing and cold forging and the like. However, the steel material of the present embodiment can of course also be used for applications other than cold working applications.

As described above, the steel material of the present embodiment satisfies the aforementioned Feature 1 and Feature 2. Therefore, the steel material of the present embodiment is excellent in a hydrogen embrittlement resistance characteristic when subjected to a pickling treatment, and is also excellent in a lubricant adhesion property.

### [Method for Producing Steel Material]

An example of a method for producing the steel material according to the present embodiment will now be described. The method for producing the steel material described hereinafter is one example for producing the steel material according to the present embodiment. Accordingly, a steel material composed as described above may also be produced by a production method other than the production method described hereinafter. However, the production method described hereinafter is a preferred example of a method for producing the steel material according to the present embodiment.

One example of a method for producing the steel material according to the present embodiment includes the following steps.

(Step 1) Starting material preparation step

(Step 2) Hot working step

(Step 3) Descaling treatment step

(Step 4) Spheroidizing annealing step

Each step is described hereunder.

### [(Step 1) Starting Material Preparation Step]

In the starting material preparation step, a starting material in which the content of each element in the chemical composition is within the range of the present embodiment is prepared. The starting material is produced, for example, by the following method. A molten steel having a chemical composition that satisfies

Feature 1 is produced. The molten steel is used to produce a starting material (a cast piece or an ingot) by a casting process. For example, a cast piece (a bloom) is produced by a well-known continuous casting process using the molten steel. Alternatively, an ingot is produced by a well-known ingot-making process using the molten steel.

### [(Step 2) Hot Working Step]

The prepared starting material is subjected to hot working to produce an intermediate steel material. In the case of performing hot rolling as the hot working, for example, the following method is available. On the assumption that the hot working step is a step of performing hot rolling, the hot working step includes a rough rolling process of subjecting the starting material to rough rolling to form the starting material into a billet, and a finish rolling process of subjecting the billet to finish rolling to make the billet into an intermediate steel material.

### [Rough Rolling Process]

In the rough rolling process, for example, the following process is performed. The starting material (ingot or cast piece) is heated, and thereafter is subjected to blooming using a blooming mill. As necessary, after blooming, the starting material is further subjected to rolling using a continuous mill to produce a billet. In the continuous mill, horizontal roll stands and vertical roll stands are alternately arranged in a row. The starting material is rolled using grooves formed in the rolling rolls of the respective stands of the continuous mill to form the starting material into a billet.

### [Finish Rolling Process]

In the finish rolling process, for example, the following process is performed. The billet is charged into a heating furnace and heated. The heated billet is then subjected to finish rolling (hot rolling) with a finish-rolling mill train to produce an intermediate steel material. The finish-rolling mill train includes a plurality of stands arranged in a row. Each stand includes a plurality of rolls arranged around a pass line. The billet is rolled using grooves formed in the rolling rolls of the respective stands to produce an intermediate steel material.

### [(Step 3) Descaling Treatment Step]

In the descaling treatment step, oxide scale formed on the surface of the intermediate steel material produced in the hot working step is removed. The descaling treatment step includes a pickling treatment process and a water washing process. Each step is described hereunder.

### [Pickling Treatment Process]

In the pickling treatment process, the intermediate steel material is immersed in an acidic solution to remove oxide scale on the surface of the intermediate steel material. The pickling treatment process is performed, for example, under the following Condition 1 to Condition 3.

Condition 1: Temperature T1 (° C.) of acidic solution: 30 to 60° ° C.

Condition 2: Hydrochloric acid concentration C1 (mass %) in acidic solution: 5.0 to 20.0% by mass

Condition 3: Immersion time t1 (minutes) in acidic solution: 2.0 to 10.0 minutes

Condition 1 to Condition 3 are described hereunder.

[Condition 1 to Condition 3: Regarding Acidic Solution Temperature T1, Hydrochloric Acid Concentration C1, and Immersion Time t1]

If the temperature T1 of the acidic solution is too high, or if the hydrochloric acid concentration C1 in the acidic solution is too high, or if the immersion time t1 in the acidic solution is too long, the surface of the intermediate steel material after the pickling treatment process will be excessively roughened by corrosion by the acid, and unevenness of the surface will increase. In such a case, the surface area of the intermediate steel material will increase. Consequently, oxide scale formed on the surface of the intermediate steel material will thicken during heating in the subsequent spheroidizing annealing step. When the oxide scale becomes thicker, the amount of Cr and amount of Mo which migrate (diffuse) from carbides in the intermediate steel material to the steel material surface and are absorbed by the oxide scale increase. Therefore, the Cr concentration [Cr] and Mo concentration [Mo] in an extraction residue of the steel material will be too low.

On the other hand, if the temperature T1 of the acidic solution is too low, or if the hydrochloric acid concentration CI in the acidic solution is too low, or if the immersion time t1 in the acidic solution is too short, oxide scale on the intermediate steel material surface will not have been removed sufficiently after the pickling treatment process. Therefore, in the subsequent spheroidizing annealing step, the amount of oxide scale formed on the surface of the intermediate steel material will be insufficient. In such a case, the amount of Cr and amount of Mo which migrate (diffuse) from carbides in the intermediate steel material to the steel material surface and are absorbed by oxide scale will be insufficient. Therefore, the Cr concentration [Cr] and Mo concentration [Mo] in an extraction residue of the steel material will be too high.

If the acidic solution temperature T1 is 30 to 60° C., the hydrochloric acid concentration C1 in the acidic solution is 5.0 to 20.0% by mass, and the immersion time t1 is 2.0 to 10.0 minutes, on the precondition that the conditions pertaining to the other production processes are satisfied, the Cr concentration [Cr] and Mo concentration [Mo] in an extraction residue of the steel material will be in an appropriate range.

A preferable lower limit of the acidic solution temperature T1 is 33ºC, and a preferable upper limit is 57ºC. A preferable lower limit of the hydrochloric acid concentration Cl in the acidic solution is 5.3% by mass, and a preferable upper limit is 19.7% by mass. A preferable lower limit of the immersion time t1 is 2.3 minutes, and a preferable upper limit is 9.7 minutes.

### [Water Washing Process]

In the water washing process, the intermediate steel material after the pickling treatment process is immersed in a water tank to remove acidic solution adhering to the surface of the intermediate steel material. The water washing process is performed, for example, under the following Condition 4.

Condition 4: Immersion time tw in water tank: 1.0 to 5.0 minutes

### [Condition 4: Regarding Immersion Time Tw]

If the immersion time tw in the water tank is too short, an excessive amount of acidic solution will remain on the surface of the intermediate steel material after the pickling treatment process. In such a case, during spheroidizing annealing that is the subsequent step, the surface of the intermediate steel material will easily oxidize. Consequently, during the spheroidizing annealing, Cr and Mo will migrate excessively from carbides in the intermediate steel material to the steel material surface and will oxidize. As a result, the Cr concentration [Cr] and Mo concentration [Mo] in an extraction residue of the steel material will be too low.

On the other hand, if the immersion time tw is too long, an insufficient amount of acidic solution will remain on the surface of the intermediate steel material after the pickling treatment process. In this case, during the spheroidizing annealing step that is the subsequent step, it will be difficult for the surface of the intermediate steel material to oxidize. Consequently, during the spheroidizing annealing, it will be difficult for Cr and Mo to migrate from carbides in the intermediate steel material to the steel material surface. As a result, the Cr concentration [Cr] and Mo concentration [Mo] in an extraction residue of the steel material will be too high.

If the immersion time tw in the water tank is 1.0 to 5.0 minutes, on the precondition that the conditions pertaining to the other production processes are satisfied, the Cr concentration [Cr] and Mo concentration [Mo] in an extraction residue of the steel material will be in an appropriate range.

A preferable lower limit of the immersion time tw in the water tank is 1.3 minutes, and a preferable upper limit is 4.7 minutes. Note that, the temperature of the water in the water tank is, for example, 10 to 50° C. Preferably, the temperature of the water is normal temperature (5 to 35° C.).

### [(Step 4) Spheroidizing Annealing Step]

In the spheroidizing annealing step, the intermediate steel material after the descaling treatment step is subjected to spheroidizing annealing to produce the steel material of the present embodiment. In spheroidizing annealing, carbides, which are represented by cementite, are spheroidized to thereby increase the cold workability of the steel material. The spheroidizing annealing step is performed, for example, under the following Condition 5 to Condition 7.

Condition 5: Gas concentration ratio RG=reducing gas concentration/oxygen concentration in atmosphere: 100 to 1000

Condition 6: Annealing temperature T2: 680 to 840° ° C.

Condition 7: Annealing time t2: 0.1 to 3.0 hours

Condition 5 to Condition 7 are described hereunder.

### [Condition 5: Regarding Gas Concentration Ratio RG]

In the spheroidizing annealing, a reducing gas is introduced into the atmosphere to suppress surface oxidation of the intermediate steel material during annealing. The reducing gas is, for example, one or more kinds of element selected from the group consisting of CO, H₂, and hydrocarbon gases. If the reducing gas concentration in the atmosphere is too low compared to the oxygen concentration in the atmosphere, the surface of the intermediate steel material will be excessively oxidized. In such a case, Cr and Mo will migrate excessively from the carbides in the intermediate steel material to the steel material surface. As a result, the Cr concentration [Cr] and Mo concentration [Mo] in an extraction residue of the steel material will be low.

On the other hand, if the reducing gas concentration in the atmosphere is too high compared to the oxygen concentration in the atmosphere, oxidation of the intermediate steel material surface will be insufficient. In such a case, the Cr concentration [Cr] and Mo concentration [Mo] in an extraction residue of the steel material will be high.

A ratio of the reducing gas concentration in the atmosphere to the oxygen concentration in the atmosphere is defined as “gas concentration ratio RG”. That is, RG is represented by the following formula.

$$Gas concentration ratio RG = reducing gas concentration / oxygen concentration in atmosphere$$

If the gas concentration ratio RG is 100 to 1000, on the precondition that the conditions pertaining to the other production processes are satisfied, the Cr concentration [Cr] and Mo concentration [Mo] in an extraction residue of the steel material will be in an appropriate range.

[Condition 6 and Condition 7: Regarding Annealing Temperature T2 and Annealing Time t2]

In the spheroidizing annealing step, the annealing temperature T2 is, for example, 680 to 840° C., and the annealing time t2 is, for example, 0.1 to 3.0 hours. If the annealing temperature T2 and the annealing time t2 are within the aforementioned ranges, the Cr concentration [Cr] and Mo concentration [Mo] in an extraction residue of the steel material will be in an appropriate range.

A preferable annealing temperature T2 and a preferable annealing time t2 are as follows.

Annealing temperature T2: 700 to 800° ° C.

Annealing time t2: 0.5 to 2.0 hours

If the annealing temperature T2 is 700 to 800° C., and the annealing time t2 is 0.5 to 2.0 hours, the coarse carbides number ratio RN in an outer layer region of the steel material will be 5 to 20%. In such a case, the hydrogen embrittlement resistance characteristic of the steel material during pickling will be further enhanced, and the lubricant adhesion property will also be further enhanced.

The steel material according to the present embodiment is produced by the production process described above.

[Regarding Production Process in Case where Steel Material of Present Embodiment is Subjected to Cold Working]

A case where the steel material of the present embodiment is a starting material for a machine part for structural use will be assumed. In this case, in the process for producing the machine part for structural use, the steel material may be subjected to a descaling treatment that includes a pickling treatment. Further, in some cases the steel material that underwent the descaling treatment may be subjected to a lubricant coating treatment, and thereafter subjected to wire drawing. When the steel material of the present embodiment is subjected to the aforementioned production process (a descaling treatment including a pickling treatment, and thereafter a lubricant coating treatment), an excellent hydrogen embrittlement resistance characteristic after the pickling treatment, and an excellent lubricant adhesion property can both be compatibly obtained in the steel material of the present embodiment.

### EXAMPLES

Hereunder, the advantageous effects of one aspect of the steel material of the present embodiment are described more specifically by way of examples. The conditions adopted in the following examples are one example of conditions adopted for confirming the feasibility and advantageous effects of the steel material of the present embodiment. Accordingly, the steel material of the present embodiment is not limited to this one example of conditions.

Molten steels having the chemical composition shown in Table 1-1 and Table 1-2 were produced.

TABLE 1-1

| Test | Chemical Composition (unit is mass %; balance is Fe and impurities) | | | | | | | | | | |
|---|---|---|---|---|---|---|---|---|---|---|---|
| No. | C | Si | Mn | P | S | Cr | Mo | Al | N | Cu | Ni |
| 1 | 0.50 | 0.03 | 0.25 | 0.007 | 0.016 | 1.12 | 0.34 | 0.012 | 0.011 | — | — |
| 2 | 0.30 | 0.18 | 0.24 | 0.006 | 0.005 | 1.49 | 0.43 | 0.061 | 0.023 | — | — |
| 3 | 0.43 | 0.40 | 0.32 | 0.019 | 0.023 | 1.21 | 0.40 | 0.021 | 0.017 | — | — |
| 4 | 0.34 | 0.27 | 0.60 | 0.007 | 0.011 | 0.95 | 0.57 | 0.040 | 0.018 | — | — |
| 5 | 0.41 | 0.03 | 0.10 | 0.011 | 0.008 | 1.13 | 0.55 | 0.066 | 0.010 | — | — |
| 6 | 0.39 | 0.12 | 0.22 | 0.030 | 0.003 | 1.13 | 0.72 | 0.018 | 0.010 | — | — |
| 7 | 0.40 | 0.12 | 0.28 | 0.003 | 0.030 | 1.51 | 0.35 | 0.021 | 0.021 | — | — |
| 8 | 0.35 | 0.32 | 0.54 | 0.003 | 0.003 | 1.80 | 0.58 | 0.045 | 0.017 | — | — |
| 9 | 0.40 | 0.18 | 0.17 | 0.018 | 0.021 | 1.75 | 0.70 | 0.029 | 0.010 | — | — |
| 10 | 0.36 | 0.03 | 0.52 | 0.019 | 0.003 | 1.70 | 0.54 | 0.011 | 0.021 | — | — |
| 11 | 0.42 | 0.29 | 0.16 | 0.007 | 0.022 | 1.65 | 0.42 | 0.062 | 0.016 | — | — |
| 12 | 0.41 | 0.12 | 0.54 | 0.005 | 0.008 | 0.93 | 0.63 | 0.042 | 0.020 | — | — |
| 13 | 0.39 | 0.34 | 0.24 | 0.009 | 0.018 | 0.92 | 0.66 | 0.033 | 0.027 | — | — |
| 14 | 0.35 | 0.21 | 0.25 | 0.011 | 0.015 | 0.91 | 0.48 | 0.061 | 0.027 | — | — |
| 15 | 0.39 | 0.18 | 0.37 | 0.003 | 0.017 | 0.90 | 0.42 | 0.029 | 0.015 | — | — |
| 16 | 0.40 | 0.09 | 0.21 | 0.016 | 0.018 | 1.40 | 1.00 | 0.012 | 0.017 | — | — |
| 17 | 0.42 | 0.20 | 0.53 | 0.003 | 0.018 | 1.17 | 0.95 | 0.066 | 0.010 | — | — |
| 18 | 0.35 | 0.24 | 0.32 | 0.015 | 0.021 | 1.41 | 0.90 | 0.047 | 0.016 | — | — |
| 19 | 0.41 | 0.24 | 0.53 | 0.023 | 0.023 | 1.02 | 0.85 | 0.053 | 0.024 | — | — |
| 20 | 0.34 | 0.05 | 0.18 | 0.003 | 0.013 | 0.94 | 0.33 | 0.035 | 0.016 | — | — |
| 21 | 0.37 | 0.15 | 0.20 | 0.011 | 0.008 | 1.21 | 0.32 | 0.015 | 0.015 | — | — |
| 22 | 0.33 | 0.07 | 0.44 | 0.010 | 0.024 | 0.94 | 0.31 | 0.041 | 0.012 | — | — |
| 23 | 0.39 | 0.26 | 0.31 | 0.020 | 0.007 | 1.29 | 0.30 | 0.048 | 0.018 | — | — |
| 24 | 0.34 | 0.19 | 0.23 | 0.009 | 0.015 | 1.60 | 0.60 | 0.100 | 0.022 | — | — |
| 25 | 0.36 | 0.29 | 0.52 | 0.012 | 0.004 | 1.51 | 0.63 | 0.005 | 0.017 | — | — |
| 26 | 0.39 | 0.17 | 0.30 | 0.006 | 0.003 | 1.19 | 0.76 | 0.052 | 0.030 | — | — |
| 27 | 0.42 | 0.04 | 0.19 | 0.003 | 0.006 | 1.44 | 0.56 | 0.027 | 0.003 | — | — |
| 28 | 0.42 | 0.24 | 0.46 | 0.005 | 0.003 | 1.31 | 0.45 | 0.012 | 0.010 | 0.40 | — |
| 29 | 0.36 | 0.06 | 0.19 | 0.005 | 0.022 | 1.34 | 0.47 | 0.020 | 0.026 | — | 0.40 |
| 30 | 0.35 | 0.09 | 0.17 | 0.009 | 0.023 | 1.49 | 0.54 | 0.031 | 0.016 | — | — |
| 31 | 0.35 | 0.23 | 0.42 | 0.003 | 0.013 | 1.52 | 0.69 | 0.066 | 0.021 | — | — |
| 32 | 0.39 | 0.32 | 0.52 | 0.003 | 0.022 | 1.38 | 0.52 | 0.008 | 0.007 | — | — |
| 33 | 0.42 | 0.03 | 0.23 | 0.019 | 0.005 | 1.59 | 0.60 | 0.031 | 0.013 | — | — |
| 34 | 0.36 | 0.38 | 0.35 | 0.011 | 0.003 | 1.70 | 0.75 | 0.030 | 0.016 | — | — |
| 35 | 0.43 | 0.28 | 0.28 | 0.023 | 0.010 | 1.02 | 0.62 | 0.012 | 0.007 | — | — |
| 36 | 0.41 | 0.35 | 0.24 | 0.010 | 0.018 | 1.51 | 0.47 | 0.027 | 0.006 | — | — |
| 37 | 0.36 | 0.32 | 0.42 | 0.006 | 0.024 | 0.95 | 0.64 | 0.029 | 0.023 | — | — |
| 38 | 0.37 | 0.18 | 0.36 | 0.011 | 0.010 | 1.32 | 0.47 | 0.037 | 0.024 | — | — |
| 39 | 0.37 | 0.26 | 0.31 | 0.023 | 0.011 | 1.15 | 0.35 | 0.061 | 0.024 | — | — |
| 40 | 0.43 | 0.30 | 0.21 | 0.016 | 0.024 | 1.61 | 0.76 | 0.067 | 0.006 | — | — |
| 41 | 0.43 | 0.31 | 0.53 | 0.009 | 0.023 | 1.13 | 0.47 | 0.020 | 0.010 | — | — |
| 42 | 0.34 | 0.19 | 0.32 | 0.003 | 0.015 | 1.51 | 0.57 | 0.066 | 0.014 | — | — |
| 43 | 0.36 | 0.17 | 0.53 | 0.012 | 0.011 | 1.60 | 0.55 | 0.052 | 0.023 | — | — |
| 44 | 0.43 | 0.12 | 0.16 | 0.016 | 0.003 | 1.44 | 0.34 | 0.008 | 0.014 | — | — |
| 45 | 0.38 | 0.20 | 0.24 | 0.012 | 0.004 | 1.18 | 0.67 | 0.062 | 0.024 | — | — |
| 46 | 0.37 | 0.18 | 0.24 | 0.010 | 0.006 | 1.14 | 0.71 | 0.060 | 0.022 | — | — |
| 47 | 0.42 | 0.04 | 0.19 | 0.003 | 0.022 | 1.40 | 0.47 | 0.066 | 0.015 | — | — |
| 48 | 0.41 | 0.06 | 0.44 | 0.018 | 0.011 | 1.49 | 0.40 | 0.025 | 0.009 | — | — |
| 49 | 0.37 | 0.27 | 0.54 | 0.003 | 0.007 | 1.39 | 0.45 | 0.014 | 0.018 | — | — |
| 50 | 0.42 | 0.17 | 0.28 | 0.010 | 0.003 | 0.95 | 0.63 | 0.015 | 0.012 | — | — |
| 51 | 0.38 | 0.10 | 0.44 | 0.019 | 0.009 | 1.24 | 0.42 | 0.009 | 0.022 | — | — |
| 52 | 0.37 | 0.09 | 0.42 | 0.022 | 0.010 | 1.24 | 0.41 | 0.012 | 0.020 | — | — |
| 53 | 0.40 | 0.12 | 0.61 | 0.018 | 0.011 | 1.13 | 0.41 | 0.020 | 0.023 | — | — |
| 54 | 0.34 | 0.04 | 0.29 | 0.031 | 0.022 | 1.62 | 0.81 | 0.025 | 0.014 | — | — |
| 55 | 0.33 | 0.03 | 0.54 | 0.015 | 0.031 | 1.51 | 0.76 | 0.009 | 0.011 | — | — |
| 56 | 0.42 | 0.12 | 0.32 | 0.003 | 0.003 | 1.39 | 0.68 | 0.004 | 0.022 | — | — |
| 57 | 0.37 | 0.31 | 0.27 | 0.019 | 0.022 | 0.97 | 0.42 | 0.011 | 0.002 | — | — |
| 58 | 0.33 | 0.06 | 0.27 | 0.016 | 0.003 | 1.21 | 0.81 | 0.030 | 0.014 | — | — |
| 59 | 0.32 | 0.03 | 0.25 | 0.016 | 0.005 | 1.20 | 0.81 | 0.029 | 0.017 | — | — |
| 60 | 0.33 | 0.05 | 0.26 | 0.015 | 0.002 | 1.19 | 0.80 | 0.033 | 0.011 | — | — |
| 61 | 0.34 | 0.33 | 0.46 | 0.018 | 0.012 | 0.96 | 0.68 | 0.026 | 0.021 | — | — |
| 62 | 0.33 | 0.33 | 0.47 | 0.018 | 0.014 | 0.94 | 0.66 | 0.023 | 0.019 | — | — |
| 63 | 0.34 | 0.35 | 0.45 | 0.018 | 0.013 | 0.96 | 0.65 | 0.028 | 0.018 | — | — |
| 64 | 0.34 | 0.26 | 0.21 | 0.007 | 0.020 | 1.06 | 0.40 | 0.041 | 0.025 | — | — |
| 65 | 0.34 | 0.04 | 0.40 | 0.021 | 0.012 | 1.17 | 0.60 | 0.047 | 0.018 | — | — |
| 66 | 0.40 | 0.03 | 0.34 | 0.003 | 0.017 | 1.50 | 0.73 | 0.027 | 0.024 | — | — |
| 67 | 0.37 | 0.24 | 0.35 | 0.023 | 0.004 | 1.29 | 0.81 | 0.014 | 0.022 | — | — |

TABLE 1-2

| Test | Chemical Composition (unit is mass %; balance is Fe and impurities) | | | | | | | | | | |
|---|---|---|---|---|---|---|---|---|---|---|---|
| No. | V | Ti | Nb | B | W | Ca | Mg | REM | Bi | Te | Zr |
| 1 | — | — | — | — | — | — | — | — | — | — | — |
| 2 | — | — | — | — | — | — | — | — | — | — | — |
| 3 | — | — | — | — | — | — | — | — | — | — | — |
| 4 | — | — | — | — | — | — | — | — | — | — | — |
| 5 | — | — | — | — | — | — | — | — | — | — | — |
| 6 | — | — | — | — | — | — | — | — | — | — | — |
| 7 | — | — | — | — | — | — | — | — | — | — | — |
| 8 | — | — | — | — | — | — | — | — | — | — | — |
| 9 | — | — | — | — | — | — | — | — | — | — | — |
| 10 | — | — | — | — | — | — | — | — | — | — | — |
| 11 | — | — | — | — | — | — | — | — | — | — | — |
| 12 | — | — | — | — | — | — | — | — | — | — | — |
| 13 | — | — | — | — | — | — | — | — | — | — | — |
| 14 | — | — | — | — | — | — | — | — | — | — | — |
| 15 | — | — | — | — | — | — | — | — | — | — | — |
| 16 | — | — | — | — | — | — | — | — | — | — | — |
| 17 | — | — | — | — | — | — | — | — | — | — | — |
| 18 | — | — | — | — | — | — | — | — | — | — | — |
| 19 | — | — | — | — | — | — | — | — | — | — | — |
| 20 | — | — | — | — | — | — | — | — | — | — | — |
| 21 | — | — | — | — | — | — | — | — | — | — | — |
| 22 | — | — | — | — | — | — | — | — | — | — | — |
| 23 | — | — | — | — | — | — | — | — | — | — | — |
| 24 | — | — | — | — | — | — | — | — | — | — | — |
| 25 | — | — | — | — | — | — | — | — | — | — | — |
| 26 | — | — | — | — | — | — | — | — | — | — | — |
| 27 | — | — | — | — | — | — | — | — | — | — | — |
| 28 | — | — | — | — | — | — | — | — | — | — | — |
| 29 | — | — | — | — | — | — | — | — | — | — | — |
| 30 | 0.50 | — | — | — | — | — | — | — | — | — | — |
| 31 | — | 0.100 | — | — | — | — | — | — | — | — | — |
| 32 | — | — | 0.100 | — | — | — | — | — | — | — | — |
| 33 | — | — | — | 0.0100 | — | — | — | — | — | — | — |
| 34 | — | — | — | — | 0.500 | — | — | — | — | — | — |
| 35 | — | — | — | — | — | 0.010 | — | — | — | — | — |
| 36 | — | — | — | — | — | — | 0.100 | — | — | — | — |
| 37 | — | — | — | — | — | — | — | 0.100 | — | — | — |
| 38 | — | — | — | — | — | — | — | — | 0.300 | — | — |
| 39 | — | — | — | — | — | — | — | — | — | 0.300 | — |
| 40 | — | — | — | — | — | — | — | — | — | — | 0.300 |
| 41 | — | — | — | — | — | — | — | — | — | — | — |
| 42 | — | — | — | — | — | — | — | — | — | — | — |
| 43 | — | — | — | — | — | — | — | — | — | — | — |
| 44 | — | — | — | — | — | — | — | — | — | — | — |
| 45 | — | — | — | — | — | — | — | — | — | — | — |
| 46 | — | — | — | — | — | — | — | — | — | — | — |
| 47 | — | — | — | — | — | — | — | — | — | — | — |
| 48 | — | — | — | — | — | — | — | — | — | — | — |
| 49 | — | — | — | — | — | — | — | — | — | — | — |
| 50 | — | — | — | — | — | — | — | — | — | — | — |
| 51 | — | — | — | — | — | — | — | — | — | — | — |
| 52 | — | — | — | — | — | — | — | — | — | — | — |
| 53 | — | — | — | — | — | — | — | — | — | — | — |
| 54 | — | — | — | — | — | — | — | — | — | — | — |
| 55 | — | — | — | — | — | — | — | — | — | — | — |
| 56 | — | — | — | — | — | — | — | — | — | — | — |
| 57 | — | — | — | — | — | — | — | — | — | — | — |
| 58 | — | — | — | — | — | — | — | — | — | — | — |
| 59 | — | — | — | — | — | — | — | — | — | — | — |
| 60 | — | — | — | — | — | — | — | — | — | — | — |
| 61 | — | — | — | — | — | — | — | — | — | — | — |
| 62 | — | — | — | — | — | — | — | — | — | — | — |
| 63 | — | — | — | — | — | — | — | — | — | — | — |
| 64 | — | — | — | — | — | — | — | — | — | — | — |
| 65 | — | — | — | — | — | — | — | — | — | — | — |
| 66 | — | — | — | — | — | — | — | — | — | — | — |
| 67 | — | — | — | — | — | — | — | — | — | — | — |

The symbol “-” in Table 1-1 and Table 1-2 means that the content of the corresponding element is 0% in significant figures (numerical value to the least significant digit) defined in the embodiment. In other words, the symbol “-” means that the content of the corresponding element is 0% when a fraction in significant figures (numerical value to the least significant digit) defined in the aforementioned embodiment is rounded off.

For example, the content of Cu defined in the present embodiment is defined by a numerical value up to the second decimal place. Accordingly, in the case of Test No. 1 in Table 1-1, the symbol “-” means that, when the measured content of Cu was rounded off to two decimal places, the content was 0%.

Further, the content of Ni defined in the present embodiment is defined by a numerical value up to the second decimal place. Accordingly, in the case of Test No. 1 in Table 1-1, the symbol “-” means that, when the measured content of Ni was rounded off to two decimal places, the content was 0%.

Note that, the term “rounded off” means that if a digit (fraction) below the defined least significant digit is less than 5, it is rounded down, and if it is 5 or more, it is rounded up.

Each of the molten steels in Tables 1-1 and 1-2 was subjected to continuous casting and produced into a bloom. The bloom was subjected to a hot working step (rough rolling process and finish rolling process). Specifically, in the rough rolling process, after heating the bloom to 1200° C., hot rolling was performed to produce a billet having a cross-sectional shape with dimensions of 160 mm×160 mm.

In the finish rolling process, after heating the billet to 1200° C., hot rolling was performed to produce a steel bar (intermediate steel material) having a diameter of 10 mm. The intermediate steel material after the hot rolling was allowed to cool.

The intermediate steel material was subjected to a descaling treatment step (a pickling treatment process and a water washing process). In the pickling treatment process, the temperature T1 of the acidic solution (C), the hydrochloric acid concentration C1 (mass %) in the acidic solution, and the immersion time t1 (minutes) in the pickling solution were as shown in Table 2. The immersion time tw (minutes) in the water tank in the water washing process was as shown in Table 2. Note that, temperature of the water in the water tank used in the water washing process was 25° C.

TABLE 2

| | Descaling Treatment Step | | | | | | | | | | |
|---|---|---|---|---|---|---|---|---|---|---|---|
| | Pickling Treatment Process | | | Water | | | | | | Hydrogen | |
| | | Hydrochloric | | Washing | Spheroidizing Annealing Step | | | | Coarse | Embrit- | |
| | | Acid | | Process | | Annealing | | | Carbides | tlement | |
| | Temperature | Concentration | Immersion | Immersion | Gas | Temperature | Annealing | F1 = | Number | Resistance | Lubricant |
| Test | T1 | C1 | Time t1 | Time tw | Concentration | T2 | Time t2 | [Cr] + | Ratio RN | Charac- | Adhesion |
| No. | (° C.) | (mass %) | (minutes) | (minutes) | Ratio RG | (° C.) | (hours) | [Mo] | (%) | teristic | Property |
| 1 | 52 | 9.7 | 7.3 | 3.0 | 476 | 758 | 1.6 | 24.3 | 14 | A | A |
| 2 | 46 | 17.1 | 9.5 | 2.5 | 800 | 753 | 0.7 | 23.0 | 11 | A | A |
| 3 | 48 | 18.2 | 4.9 | 3.5 | 165 | 766 | 1.6 | 13.7 | 15 | A | A |
| 4 | 42 | 15.8 | 7.7 | 3.7 | 422 | 771 | 1.6 | 23.9 | 15 | D | A |
| 5 | 44 | 13.9 | 6.0 | 3.8 | 462 | 753 | 0.6 | 26.9 | 9 | A | A |
| 6 | 53 | 7.4 | 5.7 | 1.6 | 712 | 751 | 1.2 | 26.5 | 11 | D | A |
| 7 | 46 | 19.3 | 7.5 | 1.5 | 798 | 728 | 0.9 | 16.6 | 8 | D | A |
| 8 | 37 | 19.3 | 9.4 | 1.7 | 150 | 743 | 1.3 | 14.6 | 11 | A | D |
| 9 | 56 | 10.8 | 7.8 | 1.5 | 181 | 758 | 1.1 | 17.8 | 11 | A | C |
| 10 | 38 | 18.9 | 3.2 | 2.0 | 341 | 732 | 1.9 | 19.8 | 13 | A | B |
| 11 | 42 | 14.8 | 6.0 | 2.8 | 226 | 744 | 0.7 | 21.0 | 8 | A | A |
| 12 | 36 | 18.4 | 6.9 | 3.7 | 555 | 737 | 0.6 | 25.9 | 8 | A | A |
| 13 | 42 | 11.3 | 3.7 | 1.9 | 605 | 781 | 0.9 | 23.2 | 13 | B | A |
| 14 | 57 | 13.4 | 4.1 | 1.5 | 956 | 763 | 1.0 | 17.0 | 11 | C | A |
| 15 | 49 | 15.0 | 6.5 | 2.4 | 492 | 717 | 1.0 | 16.6 | 8 | D | A |
| 16 | 47 | 14.9 | 8.0 | 4.5 | 145 | 758 | 0.6 | 26.4 | 9 | A | D |
| 17 | 55 | 17.2 | 6.9 | 2.9 | 741 | 752 | 1.9 | 23.0 | 15 | A | C |
| 18 | 54 | 17.7 | 7.8 | 3.4 | 670 | 746 | 0.9 | 25.5 | 9 | A | B |
| 19 | 54 | 13.5 | 8.7 | 1.6 | 448 | 776 | 1.4 | 17.2 | 15 | A | A |
| 20 | 34 | 19.0 | 6.1 | 3.4 | 491 | 718 | 1.4 | 21.9 | 9 | A | A |
| 21 | 38 | 10.7 | 7.8 | 3.3 | 139 | 725 | 1.8 | 20.5 | 12 | B | A |
| 22 | 57 | 14.0 | 4.2 | 2.3 | 396 | 775 | 1.1 | 13.1 | 13 | C | A |
| 23 | 56 | 12.5 | 8.0 | 3.6 | 376 | 763 | 1.7 | 22.2 | 15 | D | A |
| 24 | 38 | 19.3 | 3.9 | 2.6 | 204 | 766 | 1.0 | 18.6 | 12 | A | A |
| 25 | 47 | 17.0 | 9.3 | 1.7 | 757 | 770 | 1.6 | 21.0 | 15 | D | A |
| 26 | 54 | 18.3 | 3.5 | 1.5 | 530 | 767 | 0.6 | 13.2 | 10 | A | A |
| 27 | 44 | 8.4 | 4.7 | 1.8 | 218 | 750 | 1.5 | 21.6 | 13 | D | A |
| 28 | 45 | 16.1 | 7.5 | 2.8 | 609 | 749 | 1.4 | 22.8 | 12 | S | D |
| 29 | 45 | 7.2 | 3.6 | 1.9 | 254 | 723 | 1.8 | 22.4 | 11 | S | D |
| 30 | 55 | 11.7 | 9.0 | 3.8 | 141 | 753 | 1.8 | 21.6 | 14 | S | A |
| 31 | 55 | 15.5 | 2.9 | 2.5 | 777 | 753 | 0.6 | 24.0 | 8 | S | A |
| 32 | 44 | 16.0 | 8.4 | 3.3 | 287 | 740 | 1.3 | 21.7 | 11 | S | A |
| 33 | 55 | 17.7 | 7.5 | 2.3 | 237 | 754 | 0.9 | 13.3 | 10 | A | A |
| 34 | 54 | 18.2 | 3.4 | 1.6 | 534 | 772 | 0.6 | 13.5 | 11 | A | A |
| 35 | 54 | 10.2 | 5.4 | 4.4 | 228 | 752 | 1.1 | 26.2 | 11 | A | A |
| 36 | 35 | 17.5 | 3.2 | 1.5 | 531 | 766 | 0.5 | 13.1 | 12 | A | A |
| 37 | 35 | 19.1 | 6.1 | 2.1 | 505 | 718 | 1.3 | 22.3 | 10 | A | A |
| 38 | 38 | 7.2 | 7.3 | 1.9 | 296 | 778 | 1.3 | 24.1 | 14 | A | A |
| 39 | 48 | 15.2 | 8.6 | 2.5 | 752 | 725 | 0.9 | 20.8 | 8 | A | A |
| 40 | 35 | 17.3 | 8.5 | 1.3 | 560 | 746 | 1.6 | 23.2 | 13 | A | A |
| 41 | 30 | 5.0 | 2.0 | 1.0 | 100 | 750 | 1.3 | 30.0 | 14 | A | D |
| 42 | 33 | 5.3 | 2.3 | 1.3 | 130 | 743 | 1.4 | 29.0 | 8 | A | C |
| 43 | 57 | 19.7 | 9.7 | 4.7 | 970 | 766 | 1.0 | 11.0 | 14 | C | A |
| 44 | 60 | 20.0 | 10.0 | 5.0 | 1000 | 743 | 1.4 | 10.0 | 10 | D | A |
| 45 | 51 | 10.2 | 7.3 | 3.0 | 401 | 825 | 1.0 | 24.3 | 25 | A | E |
| 46 | 48 | 9.8 | 8.1 | 2.1 | 393 | 774 | 2.5 | 20.1 | 25 | A | E |
| 47 | 37 | 12.1 | 6.1 | 4.0 | 489 | 800 | 2.0 | 23.4 | 20 | A | C |
| 48 | 42 | 15.8 | 6.0 | 3.3 | 556 | 785 | 1.9 | 26.0 | 19 | A | B |
| 49 | 41 | 13.7 | 5.7 | 3.8 | 537 | 715 | 0.6 | 13.3 | 6 | B | A |
| 50 | 38 | 12.7 | 5.5 | 2.9 | 602 | 700 | 0.5 | 21.7 | 5 | C | A |
| 51 | 44 | 10.0 | 9.6 | 3.4 | 310 | 690 | 0.8 | 25.7 | 2 | E | A |
| 52 | 39 | 9.8 | 9.4 | 3.5 | 299 | 754 | 0.2 | 24.6 | 2 | E | A |
| 53 | 35 | 10.5 | 4.8 | 2.2 | 356 | 766 | 0.8 | 22.8 | 11 | x | A |
| 54 | 38 | 12.0 | 6.7 | 3.1 | 146 | 745 | 0.9 | 25.9 | 9 | x | A |
| 55 | 50 | 17.8 | 7.3 | 3.2 | 225 | 751 | 0.7 | 19.0 | 9 | x | A |
| 56 | 38 | 15.4 | 8.9 | 3.8 | 269 | 781 | 1.1 | 26.8 | 14 | x | A |
| 57 | 37 | 15.3 | 6.6 | 3.1 | 349 | 747 | 1.4 | 21.2 | 12 | x | A |
| 58 | 29 | 12.2 | 6.6 | 1.6 | 670 | 734 | 1.4 | 30.1 | 10 | A | x |
| 59 | 35 | 4.0 | 5.7 | 1.5 | 665 | 734 | 1.2 | 30.5 | 13 | A | x |
| 60 | 38 | 13.5 | 1.0 | 1.8 | 657 | 740 | 1.6 | 30.5 | 9 | A | x |
| 61 | 61 | 11.2 | 5.6 | 1.7 | 617 | 759 | 0.7 | 9.6 | 10 | x | A |
| 62 | 39 | 21.0 | 4.7 | 1.9 | 615 | 764 | 0.9 | 9.9 | 10 | x | A |
| 63 | 42 | 10.9 | 11.0 | 1.6 | 612 | 771 | 1.0 | 8.9 | 10 | x | A |
| 64 | 54 | 15.1 | 2.4 | 5.5 | 559 | 757 | 1.6 | 30.6 | 14 | A | x |
| 65 | 39 | 18.9 | 4.7 | 0.5 | 256 | 738 | 0.9 | 9.9 | 8 | x | A |
| 66 | 47 | 10.9 | 3.5 | 2.3 | 1010 | 730 | 1.3 | 31.7 | 10 | A | x |
| 67 | 54 | 17.3 | 2.7 | 2.7 | 97 | 759 | 0.9 | 9.0 | 10 | x | A |

The steel bar after the descaling treatment step was subjected to a spheroidizing annealing step. The gas concentration ratio RG, the annealing temperature T2 (° C.), and the annealing time t2 (hours) in the spheroidizing annealing were as shown in Table 2. Steel materials (steel bars) were produced by the production process described above. The diameters of the steel materials ranged from 10 to 40 mm.

### [Evaluation Tests]

The steel material of each test number was subjected to the following evaluation tests.

(Test 1) Test for measuring chemical composition of steel material

(Test 2) Test for measuring Cr concentration [Cr] and Mo concentration [Mo] in extraction residue

(Test 3) Test for measuring coarse carbides number ratio RN

(Test 4) Microstructure observation test

(Test 5) Hydrogen embrittlement resistance characteristic evaluation test

(Test 6) Lubricant adhesion property evaluation test

Test 1 to Test 6 are described hereunder.

### [(Test 1) Test for Measuring Chemical Composition of Steel Material]

Based on the method described in the foregoing [Method for measuring chemical composition of steel material], the chemical composition of the steel material of each test number was determined. The results of the measurement showed that the steel materials of all of the test numbers had the chemical compositions described in Tables 1-1 and 1-2.

### [(Test 2) Test for Measuring Cr Concentration [Cr] and Mo Concentration [Mo] in Extraction Residue]

Based on the method described in the foregoing [Method for measuring Cr concentration [Cr] and Mo concentration [Mo] in extraction residue], F1 (=[Cr]+[Mo]) that is the total amount of the Cr concentration [Cr] (mass %) and the Mo concentration [Mo] (mass %) in an outer layer region of the steel material of each test number was determined. The determined F1 values are shown in Table 2.

### [(Test 3) Test for Measuring Coarse Carbides Number Ratio RN]

Based on the method described in the foregoing [Method for measuring coarse carbides number ratio RN], the coarse carbides number ratio RN (%) of the steel material of each test number was determined. The determined coarse carbides number ratios RN are shown in Table 2.

### [(Test 4) Microstructure Observation Test]

The steel material of each test number was subjected to microstructure observation based on the method described in the foregoing [Method for identifying microstructure]. As a result, it was found that in each test number, the microstructure of the steel material was a structure consisting of a BCC phase in which carbides were dispersed (BCC structure).

### [(Test 5) Hydrogen Embrittlement Resistance Characteristic Evaluation Test]

Assuming the performance of a descaling treatment step, the steel material of each test number was subjected to the following pickling treatment process and water washing process. In the pickling treatment process, the steel material of each test number was immersed for 5.0 minutes in an acidic solution at 40° C. The hydrochloric acid concentration in the acidic solution was 15.0% by mass. In the water washing process, the steel material after the pickling treatment process was immersed for 1.0 minute in a water tank in which water at a temperature of 25° C. was stored.

The steel material after the water washing process was cut perpendicularly to the axial direction (rolling direction) of the steel material at four different locations in the axial direction to obtain four test specimens for a tensile test which each had a diameter of 10 mm and a length of 500 mm. The shape of each test specimen conformed to the No. 14A test coupon specified in JIS Z 2241: 2011. The four test specimens were divided into two groups which each consisted of two test specimens (group 1 and group 2).

After one hour had elapsed after completion of the water washing process, the two test specimens of group 1 were subjected to a tensile test. That is, a tensile test was conducted on the test specimens of group 1 in a state in which there was a possibility of embrittlement occurring due to hydrogen that penetrated into the steel material in the pickling treatment process. On the other hand, with respect to the two test specimens of group 2, the two test specimens were left to stand in atmospheric air at normal temperature for 168 hours (one week) from the time of completing the water washing process, to thereby remove hydrogen from the test specimens. A tensile test was then conducted on the test specimens after the dehydrogenation. That is, a tensile test was conducted on the test specimens of group 2 in a state in which there was no possibility of hydrogen embrittlement.

For each of the groups, a tensile test was conducted according to JIS B 1051: 2014 in atmospheric air at normal temperature (25° C.), and the tensile strengths (MPa) of the two test specimens were determined. For each of the groups (group 1 or group 2), the arithmetic average value of the tensile strengths (MPa) of the two test specimens was defined as the tensile strength (MPa) of the relevant group (group 1 or group 2). Specifically, the arithmetic average value of the tensile strengths of the two test specimens of group 1 was defined as tensile strength 1 (MPa), and the arithmetic average value of the tensile strengths of the two test specimens of group 2 was defined as tensile strength 2 (MPa).

A hydrogen embrittlement resistance index HI was defined by the following equation.

$$Hydrogen embrittlement resistance index HI = tensile strength 1 / tensile strength 2$$

The hydrogen embrittlement resistance characteristic was evaluated as follows depending on the obtained hydrogen embrittlement resistance index HI.

Evaluation S: hydrogen embrittlement resistance index HI is 0.95 to 1.00

Evaluation A: hydrogen embrittlement resistance index HI is 0.90 to less than 0.95

Evaluation B: hydrogen embrittlement resistance index HI is 0.85 to less than 0.90

Evaluation C: hydrogen embrittlement resistance index HI is 0.80 to less than 0.85

Evaluation D: hydrogen embrittlement resistance index HI is 0.75 to less than 0.80

Evaluation E: hydrogen embrittlement resistance index HI is 0.70 to less than 0.75

Evaluation X: hydrogen embrittlement resistance index HI is less than 0.70

In a case of Evaluation S to Evaluation E, it was determined that the relevant steel material was excellent in a hydrogen embrittlement resistance characteristic. On the other hand, in a case of Evaluation X, it was determined that the hydrogen embrittlement resistance characteristic of the steel material was low. The evaluation results are shown in Table 2.

### [(Test 6) Lubricant Adhesion Property Evaluation Test]

The lubricant adhesion property of each test number was evaluated by the following method.

Assuming the performance of a descaling treatment step, the steel material of each test number was subjected to the following pickling treatment process and water washing process. In the pickling treatment process, the steel material of each test number was immersed for 5.0 minutes in an acidic solution at 40° C. The hydrochloric acid concentration in the acidic solution was 15.0% by mass. In the water washing process, the steel material after the pickling treatment process was immersed for 1.0 minute in a water tank in which water at a temperature of 25° ° C. was stored.

The steel material after the water washing process was subjected to a lubricant coating treatment. Specifically, a chemical treatment was performed on the steel material to form a phosphate coating on the surface of the steel material. The bath temperature of a phosphate bath was set to 70° ° C., and the treatment time was set to 10 minutes. Zinc phosphate was used as the phosphate. Thereafter, the steel material was immersed for 10 minutes in a soap treatment solution containing a soap lubricant having sodium stearate as a main component, to cause soap (metallic soap and unreacted soap) to adhere onto the phosphate coating. By performing the above process, lubricants (soap and a phosphate coating) were applied to the steel material surface.

At five different locations in the axial direction of the steel material to which the lubricant was applied, the steel material was cut perpendicularly to the axial direction to obtain five test specimens which each had a diameter of 10 mm and a length of 200 mm. First, a total weight 1 of the five test specimens was determined. Next, the five test specimens were immersed for 15 minutes in a chromic acid aqueous solution at 70° C., which completely removed the lubricant. A total weight 2 of the five test specimens after immersion was determined. A value obtained by subtracting the total weight 2 from the total weight 1 was defined as a lubricant coating amount (g). The lubricant coating amount was divided by the total area of the surfaces other than the cut surfaces of the five test specimens (that is, π×10 mm×200 mm×5 (mm²)) to determine a lubrication coating amount LA (g/m²) per unit area. The lubricant adhesion property was evaluated as follows depending on the lubrication coating amount LA.

Evaluation A: lubrication coating amount LA is 10 g/m² or more

Evaluation B: lubrication coating amount LA is 8 to less than 10 g/m²

Evaluation C: lubrication coating amount LA is 6 to less than 8 g/m²

Evaluation D: lubrication coating amount LA is 4 to less than 6 g/m²

Evaluation E: lubrication coating amount LA is 2 to less than 4 g/m²

Evaluation X: lubrication coating amount LA is less than 2 g/m²

In a case of Evaluation A to Evaluation E, it was determined that the relevant steel material was excellent in a lubricant adhesion property. In a case of Evaluation X, it was determined that the lubricant adhesion property of the relevant steel material was low. The evaluation results are shown in Table 2.

### [Evaluation Results]

Referring to Table 1-1, Table 1-2 and Table 2, the chemical compositions of the steel materials of Test Nos. 1 to 52 were appropriate, and in addition, for these steel materials, F1 satisfied Formula (1). Therefore, the steel materials of Test Nos. 1 to 52 were excellent in a hydrogen embrittlement resistance characteristic after a pickling treatment, and were also excellent in a lubricant adhesion property.

Furthermore, in Test Nos. 1 to 44 and 47 to 50, the coarse carbides number ratio RN was 5 to 20%. Therefore, in comparison to Test Nos. 45, 46, 51 and 52, the steel materials of Test Nos. 1 to 44 and 47 to 50 exhibited a more excellent hydrogen embrittlement resistance characteristic or a more excellent lubricant adhesion property.

On the other hand, in Test No. 53, the content of Mn was too high. Therefore, the hydrogen embrittlement resistance characteristic of the steel material was low.

In Test No. 54, the content of P was too high. Therefore, the hydrogen embrittlement resistance characteristic of the steel material was low.

In Test No. 55, content of S was too high. Therefore, the hydrogen embrittlement resistance characteristic of the steel material was low.

In Test No. 56, the content of Al was too low. Therefore, the hydrogen embrittlement resistance characteristic of the steel material was low.

In Test No. 57, the content of N was too low. Therefore, the hydrogen embrittlement resistance characteristic of the steel material was low.

In Test No. 58, the temperature T1 of the acidic solution in the pickling treatment process was low. Therefore, the F1 value was more than the upper limit of Formula (1). As a result, the lubricant adhesion property of the steel material was low.

In Test No. 59, the hydrochloric acid concentration C1 in the acidic solution in the pickling treatment process was low. Therefore, the F1 value was more than the upper limit of Formula (1). As a result, the lubricant adhesion property of the steel material was low.

In Test No. 60, the immersion time t1 in the pickling treatment process was short. Therefore, the F1 value was more than the upper limit of Formula (1). As a result, the lubricant adhesion property of the steel material was low.

In Test No. 61, the temperature T1 of the acidic solution in the pickling treatment process was high. Therefore, the F1 value was less than the lower limit of Formula (1). As a result, the hydrogen embrittlement resistance characteristic of the steel material was low.

In Test No. 62, the hydrochloric acid concentration C1 in the acidic solution in the pickling treatment process was high. Therefore, the F1 value was less than the lower limit of Formula (1). As a result, the hydrogen embrittlement resistance characteristic of the steel material was low.

In Test No. 63, the immersion time t1 in the pickling treatment process was long. Therefore, the F1 value was less than the lower limit of Formula (1). As a result, the hydrogen embrittlement resistance characteristic of the steel material was low.

In Test No. 64, although the chemical composition was appropriate, the immersion time tw in the water washing process was too long. Therefore, F1 was more than the upper limit of Formula (1). As a result, the lubricant adhesion property of the steel material was low.

In Test No. 65, although the chemical composition was appropriate, the immersion time tw in the water washing process was too short. Therefore, F1 was less than the lower limit of Formula (1). As a result, the hydrogen embrittlement resistance characteristic of the steel material was low.

In Test No. 66, although the chemical composition was appropriate, the gas concentration ratio RG in the atmosphere in the spheroidizing annealing step was too high. Therefore, F1 was more than the upper limit of Formula (1). As a result, the lubricant adhesion property of the steel material was low.

In Test No. 67, although the chemical composition was appropriate, the gas concentration ratio RG in the atmosphere in the spheroidizing annealing step was too low. Therefore, F1 was less than the lower limit of Formula (1). As a result, the hydrogen embrittlement resistance characteristic of the steel material was low.

An embodiment of the present disclosure has been described above. However, the foregoing embodiment is merely an example for implementing the present disclosure. Accordingly, the present disclosure is not limited to the above embodiment, and the above embodiment can be appropriately modified and implemented within a range that does not deviate from the gist of the present disclosure.

1. A steel material comprising, in mass %,
C: 0.30 to 0.50%,
Si: 0.40% or less,
Mn: 0.10 to 0.60%,
P: 0.030% or less,
S: 0.030% or less,
Cr: 0.90 to 1.80%,
Mo: 0.30 to 1.00%,
Al: 0.005 to 0.100%, and
N: 0.003 to 0.030%,
with the balance comprising Fe and impurities,
wherein:
when a Cr concentration in an extraction residue obtained by electrolyzing and removing a region from a surface of the steel material to a depth position of 100±20 μm by performing a preliminary constant current electrolysis and thereafter further electrolyzing a region from a surface of the steel material to a depth position of 100±20 μm by performing a main constant current electrolysis is defined as “[Cr]” (mass %), and a Mo concentration in the extraction residue is defined as “[Mo]” (mass %), the steel material satisfies Formula (1):
$$10. \leq [ Cr ] + [ Mo ] \leq 30. . \qquad ( 1 )$$

2. The steel material according to claim 1, wherein:
a number ratio of carbides having an equivalent circular diameter of 0.8 μm or more with respect to a number of carbides having an equivalent circular diameter of 0.5 μm or more is 5 to 20%.

3. The steel material according to claim 1, further containing, in lieu of a part of Fe, one or more kinds of element selected from a group consisting of:
Cu: 0.40% or less,
Ni: 0.40% or less,
V: 0.50% or less,
Ti: 0.100% or less,
Nb: 0.100% or less,
B: 0.0100% or less,
W: 0.500% or less,
Ca: 0.010% or less,
Mg: 0.100% or less,
rare earth metal: 0.100% or less,
Bi: 0.300% or less,
Te: 0.300% or less, and
Zr: 0.300% or less.

4. The steel material according to claim 2, further containing, in lieu of a part of Fe, one or more kinds of element selected from a group consisting of:
Cu: 0.40% or less,
Ni: 0.40% or less,
V: 0.50% or less,
Ti: 0.100% or less,
Nb: 0.100% or less,
B: 0.0100% or less,
W: 0.500% or less,
Ca: 0.010% or less,
Mg: 0.100% or less,
rare earth metal: 0.100% or less,
Bi: 0.300% or less,
Te: 0.300% or less, and
Zr: 0.300% or less.
